(19) United States
(12) Patent Application Publication
(10) Pub. No.: US 2005/0084251 A1
(43) Pub. Date: Apr. 21, 2005

(54) Digital content reproducing apparatus and method for reproducing digital content

(75) Inventors: Masaki Kitahashi, Osaka (JP); Yasunori Naruse, Shiga (JP); Satoshi Yabuta, Osaka (JP)

Correspondence Address: Jack Q. Lever, Jr.;McDERMOTT, WILL & EMERY, 600 Thirteenth Street, N.W., Washington, DC, 20005-3096, US

(73) Assignee: MATSUSHITA ELECTRIC INDUSTRIAL CO., LTD.

(21) Appl. No.: 10/963,591

(22) Filed: Oct. 14, 2004

(30) Foreign Application Priority Data
Oct. 20, 2003 (JP) 2003-358684

(51) Int. Cl. H04N 5/781

(52) U.S. Cl. 386/124; 386/125

(57) ABSTRACT

A digital content reproducing apparatus includes: a recorded data reading section for reading first reproduction control information from a storage medium; a control information reading section for reading second reproduction control information from an external memory; a control information controlling section for selecting at least one of the first and second reproduction control information as reference control information; and a reproducing means for reproducing digital content recorded on the storage medium by referring to the reference control information.

### CROSS-REFERENCE TO RELATED APPLICATION

This application is related to Japanese Patent Application No. 2003-358684 filed on Oct. 20, 2003, whose priority is claimed under 35 USC §119, the disclosure of which is incorporated by reference in its entirety.

### BACKGROUND OF THE INVENTION

The present invention relates to storage media on which digital content is recorded, apparatus for reproducing digital content recorded on storage media, methods for reproducing digital content recorded on storage media, and methods for recording secret content. In particular, the present invention relates to methods for reproducing digital content without referring to control information recorded on storage media.

Apparatus capable of not only reproducing digital content in the DVD-Video format (hereinafter, referred to as DVD-Video content) but also allowing a person to record the DVD-Video content with ease has been increasingly used recently for digital content which is available by recording it on storage media in formats such as the DVD-Video format, apparatus for reproducing digital content recorded on storage media, storage media on which data can be written only once, and others, use of.

The DVD-Video content created by general users using such recording apparatus, for example, is not satisfactory in its materials, as compared to DVD-Video content created by content providers. Hence, demands for editing, for one's enjoyment, DVD-Video content once created are expected to grow. Likewise, for storage media on the market, a request to watch only one's favorite scene selected from recorded digital content is also expected to arise.

In addition, digital content which is available via storage media may include bonus content, e.g., bonus pictures such as making pictures not contained in cassettes for conventional VCRs, bonus images, or special game content capable of being played on game machines. Accordingly, an increased number of users expecting bonus content contribute to the widespread use of digital content. On a storage medium containing such bonus content, menus for allowing a user to access the content or the like are recorded. The user can enjoy bonus content from the menus or the like using a conventional digital content reproducing apparatus (see, for example, “DVD Technical Guide Chapter 4 Video Format”<http://www.pioneer.co.jp/crdl/tech/dvd/4-e.html>[searched on May 1, 2004].)

Hereinafter, a conventional DVD-Video reproducing apparatus for reproducing the above-mentioned DVD-Video content or bonus content included therein will be specifically described with reference to the drawings.

FIG. 10 is a block diagram showing a configuration of a conventional DVD-Video reproducing apparatus.

As shown in FIG. 10, a DVD-Video reproducing apparatus 1a includes: a recorded data reading section 2; a control information analyzing section 3; a reproduction data acquiring section 4; and a reproduction data decoding section 5.

With this configuration, in the case of reproducing digital content (recorded digital content) recorded on a storage medium 6 in the DVD-Video format, for example, the control information analyzing section 3 firstly requests the recorded data reading section 2 to acquire control information (navigation data) necessary for reproducing recorded digital content from the storage medium 6. Upon the request, the recorded data reading section 2 reads the navigation data (recorded navigation data) from the storage medium 6, and then sends the recorded navigation data to the control information analyzing section 3. The control information analyzing section 3 refers to the received recorded navigation data and thereby notifies the reproduction data acquiring section 4 of a position at which reproduction of the recorded digital content actually recorded on the storage medium 6 starts. Then, the reproduction data acquiring section 4 requests the recorded data reading section 2 to acquire recorded digital content to be reproduced (hereinafter, referred to as reproduction data). Upon the request, the recorded data reading section 2 reads the requested reproduction data from the storage medium 6 and sends this reproduction data to the reproduction data acquiring section 4. The reproduction data acquiring section 4 transmits the received reproduction data to the reproduction data decoding section 5. The reproduction data decoding section 5 decodes the received reproduction data compressed in the MPEG format. In this manner, pictures and sounds based on the reproduction data are reproduced.

As described above, the conventional DVD-Video reproducing apparatus 1a refers to recorded navigation data recorded on the storage medium 6 to reproduce recorded digital content also recorded on the storage medium 6.

Now, a relationship between the structure of the recorded navigation data recorded on the storage medium 6 and data (reproduction data) to be reproduced by referring to this recorded navigation data will be described.

FIG. 11A shows a structure of recorded navigation data 10 recorded on the storage medium 6.

FIG. 11B shows data (actual data) actually recorded on the storage medium 6 and specified by the recorded navigation data 10 shown in FIG. 11A.

FIG. 11C shows the order of reproduction (reproduction order) in which the actual data shown in FIG. 11B is reproduced by referring to the recorded navigation data 10 shown in FIG. 11A.

As shown in FIG. 11A, a PGC (program chain) #1, for example, constituting the recorded navigation data 10 is composed of PGs (programs) #1 through #5 for designating CELL-IDs in the actual data. For example, CELL-ID#1 designates VOBUs (video object units) #1 and #2 in a VOBS (video object set) of the actual data.

Accordingly, the order of reproducing VOBUs (actual data) shown in FIG. 11B reproduced by referring to the recorded navigation data 10 shown in FIG. 11A is shown by FIG. 11C. Specifically, as shown in FIG. 11C, digital content units recorded on the storage medium 6 are reproduced in the order specified by the recorded navigation data 10 recorded on the same storage medium 6.

In the DVD-Video format, recorded digital content is encrypted using a CSS (content scrambling system). This prevents illegal copy of the recorded digital content.

Hereinafter, a conventional DVD-Video reproducing apparatus for reproducing encrypted recorded digital content from a storage medium provided with protection against illegal copy using a CSS will be described with reference to the drawings.

FIG. 12 is a diagram showing a configuration of a conventional DVD-Video reproducing apparatus. The same components as those of the DVD-Video reproducing apparatus 1a shown in FIG. 10 are denoted by the same reference numerals.

As shown in FIG. 12, the conventional DVD-Video reproducing apparatus 1b includes: a recorded data reading section 2; a control information analyzing section 3; a reproduction data acquiring section 4; a reproduction data decoding section 5; and an encryption key receiving section 7.

With this configuration, in the case of reproducing recorded digital content recorded on the storage medium 6 in, for example, the DVD-Video format, it is confirmed that the encryption key receiving section 7 and the recorded data reading section 2 are compatible with a CSS. Then, the encryption key receiving section 7 requests the recorded data reading section 2 to acquire an encryption key for decrypting recorded digital content recorded on the storage medium 6. Upon the request, the recorded data reading section 2 reads an encryption key from the storage medium 6, and then sends the encryption key to the encryption key receiving section 7. The encryption key receiving section 7 sets the received encryption key in the reproduction data decoding section 5. This allows the reproduction data decoding section 5 to decrypt the encrypted reproduction data. The recorded digital content is reproduced in the manner already described above.

As described above, the conventional DVD-Video reproducing apparatus 1b decrypts recorded digital content encrypted by a CSS and recorded on the storage medium 6, by using an encryption key recorded on the same storage medium 6. Accordingly, pictures and sounds based on reproduction data are reproduced. The DVD-Video format provides protection against access to a particular menu unless a simple reusable password is input. Therefore, the simple reusable password for proceeding to the particular menu for access to bonus content is previously incorporated in navigation data.

### SUMMARY OF THE INVENTION

However, in the conventional DVD-Video reproducing apparatus 1a, navigation data that is referred to for reproduction of recorded digital content recorded on the storage medium 6 is limited to the recorded navigation data 10 recorded on the same storage medium 6. That is, only reproduction according to the recorded navigation data 10 is performed. Accordingly, even if a general user wants to edit materials of DVD-Video content once created on the storage medium 6, the current DVD-Video format does not allow any edit after creation. Therefore, at present, the general user's request to edit DVD-video content created by the user is not satisfied. Furthermore, materials of the DVD-Video content on the market cannot be edited by general users, as well.

In addition, a password for allowing access to a menu of bonus content is reusable and simple, so that the password can be easily broken even in the case of using the general DVD-Video reproducing apparatus 1b. Specifically, the recorded navigation data 10 for bonus content is easily referred to using such a password. Accordingly, if the recorded navigation data 10 for the bonus content is referred to and an encryption key recorded on a disk is used, encrypted bonus content (secret content) is easily reproduced.

It is therefore an object of the present invention to allow the order of reproducing digital content in the DVD-Video format to be edited even after the digital content has been recorded on a storage medium. It is another object of the present invention to prevent illegal reproduction of secret bonus content (secret content) and illegal copy of whole content encrypted with a CSS.

In order to achieve these objects, the present inventors came up with an idea of implementing protection against edits of DVD-Video content, illegal reproduction of secret content or illegal copy of whole content encrypted with a CSS, by referring to reproduction control information different from recorded reproduction control information recorded on a storage medium.

Specifically, a first inventive digital content reproducing apparatus includes: first data reading means for reading recorded digital content from a first storage medium on which the recorded digital content is recorded; second data reading means for reading first reproduction control information from a second storage medium on which the first reproduction control information is recorded, the first reproduction control information being necessary for reproducing the recorded digital content; and reproducing means for reproducing the recorded digital content as reproduction digital content by referring to the first reproduction control information.

In the first digital content reproducing apparatus, the second data reading means reads the first reproduction control information necessary for reproducing the recorded digital content from the second storage medium different from the first storage medium on which the recorded digital content is recorded. Accordingly, even if the reproduction control information necessary for reproducing the recorded digital content is not recorded on the first storage medium on which the recorded digital content is recorded, the recorded digital content is reproduced by referring to the first reproduction control information. In other words, without the first inventive digital content reproducing apparatus, recorded digital content is not reproduced from a storage medium on which no reproduction control information is recorded. Hence, the first inventive digital content reproducing apparatus ensures protection against illegal reproduction of recorded digital content. This solves the problem of a conventional digital content reproducing apparatus that easiness of breaking a password for reproducing recorded digital content allows illegal reproduction of the recorded digital content by referring to recorded reproduction control information.

In the first inventive digital content reproducing apparatus, second reproduction control information necessary for reproducing the recorded digital content is preferably recorded on the first storage medium, the first data reading means preferably reads the second reproduction control information, the apparatus preferably further includes control information selecting means for selecting, as reference control information which is referred to for reproduction of the recorded digital content, at least one of the first reproduction control information and the second reproduction control information, and the reproducing means preferably reproduces the recorded digital content by referring to the reference control information.

Then, at least one of the second reproduction control information recorded on the first storage medium and the first reproduction control information recorded on the second storage medium is selected by the control information selecting means as the reference control information which is referred to for reproduction of the recorded digital content recorded on the first storage medium. This allows the recorded digital content recorded on the first storage medium to be reproduced not only by referring to the second reproduction control information recorded on the first storage medium but also by referring to the first reproduction control information recorded on the second storage medium. Accordingly, various reproduction digital content items are reproduced. In addition, if only part of the recorded digital content is reproduced by referring only to the second reproduction control information, reference to the first reproduction control information enables reproduction of part of the recorded digital content which is not reproduced by referring to the second reproduction control information, thus ensuring the above-described effects including protection against illegal reproduction of secret content, for example.

If the first inventive digital content reproducing apparatus includes the control information selecting means, the order of reproducing the reproduction digital content reproduced by referring to the first reproduction control information and the order of reproducing the reproduction digital content reproduced by referring to the second reproduction control information preferably differ from each other.

Then, the order of reproducing reproduction digital content by referring to the second reproduction control information recorded on the first storage medium is changed by referring to the first reproduction control information recorded on the second storage medium. That is, the order of reproducing reproduction digital content is edited only by switching the reference control information. This solves a problem of a conventional digital content reproducing apparatus that recorded digital content cannot be edited after the digital content has once been recorded on a storage medium.

If the first inventive digital content reproducing apparatus includes the control information selecting means and the recorded digital content is recorded in a DVD-Video format, each of the first reproduction control information and the second reproduction control information is preferably video title set information (VTSI) or video manager information (VMGI).

This ensures the advantages described above even for reproduction of recorded digital content in the DVD-Video format.

If the first inventive digital content reproducing apparatus includes the control information selecting means, the apparatus preferably further includes control information constructing means for constructing third reproduction control information based on at least one of the first reproduction control information and the second reproduction control information, the control information selecting means preferably selects, as the reference control information, at least one of the first reproduction control information, the second reproduction control information and the third reproduction control information.

Then, the control information constructing means allows construction of the third reproduction control information based on at least one of the first and second reproduction control information. The control information selecting means selects the third reproduction control information as the reference control information. This allows the recorded digital content to be also reproduced by referring to the third reproduction control information selected as the reference control information. Accordingly, the order of reproducing reproduction digital content by referring to the first or second reproduction control information, for example, is changed by referring to the third reproduction control information. That is, the order of reproducing the reproduction digital content is edited by switching of the reference control information. Accordingly, various reproduction digital content items are reproduced.

In the first inventive digital content reproducing apparatus, the second storage medium is preferably an internal memory, an external memory or a storage medium usable on a network.

Then, even if reproduction control information (the second reproduction control information) necessary for reproducing recorded digital content is recorded in an internal memory or an external memory or on a storage medium usable on a network, the foregoing advantages are still ensured.

A second inventive digital content reproducing apparatus includes: data reading means for reading recorded digital content, first reproduction control information and second reproduction control information from a storage medium on which the recorded digital content, the first reproduction control information and the second reproduction control information are recorded, the first reproduction control information and the second reproduction control information being necessary for reproducing the recorded digital content; control information selecting means for selecting, as reference control information which is referred to for reproduction of the recorded digital content, at least one of the first reproduction control information and the second reproduction control information, and reproducing means for reproducing the recorded digital content as reproduction digital content by referring to the reference control information.

In the second inventive digital content reproducing apparatus, the data reading means reads the first and second reproduction control information necessary for reproducing the recorded digital content from the storage medium on which the recorded digital content is recorded. Accordingly, at least one of the first and second reproduction control information recorded on the storage medium is selected as the reference control information, thus allowing reproduction of various reproduction digital content.

In the second inventive digital content reproducing apparatus, the order of reproducing the reproduction digital content by referring to the first reproduction control information and the order of reproducing the reproduction digital content by referring to the second reproduction control information preferably differ from each other.

Then, at least one of the first and second reproduction control information recorded on the first storage medium is selected as the reference control information referred to for reproduction of recorded digital content. Accordingly, the order of reproducing the reproduction digital content is changed by switching the reference control information.

In the second inventive digital content reproducing apparatus, if the recorded digital content is recorded in a DVD-Video format, each of the first reproduction control information and the second reproduction control information is preferably video title set information (VTSI) or video manager information (VMGI).

This ensures the advantages described above even for reproduction of recorded digital content in the DVD-Video format.

The second inventive digital content reproducing apparatus preferably further includes control information constructing means for constructing third reproduction control information based on at least one of the first reproduction control information and the second reproduction control information, and the control information selecting means preferably selects, as the reference control information, at least one of the first reproduction control information, the second reproduction control information and the third reproduction control information.

Then, the control information constructing means allows construction of the third reproduction control information based on at least one of the first and second reproduction control information. The control information selecting means selects the third reproduction control information as the reference control information. This allows recorded digital content to be also reproduced by referring to the third reproduction control information selected as the reference control information. Accordingly, the order of reproducing reproduction digital content by referring to the first or second reproduction control information, for example, is changed by referring to the third reproduction control information. That is, various reproduction digital content items are reproduced by switching the reference control information.

If the second inventive digital content reproducing apparatus includes the control information constructing means, the order of reproducing the reproduction digital content by referring to one of the first reproduction control information and the second reproduction control information and the order of reproducing the reproduction digital content by referring to the third reproduction control information preferably differ from each other.

Then, even only from a storage medium on which recorded digital content and reproduction control information necessary for reproducing the recorded digital content are recorded, the order of reproducing the reproduction digital content is edited by referring to the third reproduction control information constructed by the control information constructing means.

A third inventive digital content reproducing apparatus includes: reading means for reading recorded digital content and first reproduction control information from a storage medium on which the recorded digital content and the first reproduction control information are recorded, the first reproduction control information being necessary for reproducing the recorded digital content; control information constructing means for constructing second reproduction control information based on the first reproduction control information; control information selecting means for selecting, as reference control information which is referred to for reproduction of the recorded digital content, at least one of the first reproduction control information and the second reproduction control information; and reproducing means for reproducing the recorded digital content as reproduction digital content by referring to the reference control information.

In the third inventive digital content reproducing apparatus, the control information constructing means allows construction of the second reproduction control information based on the first reproduction control information recorded on the storage medium. The control information selecting means selects the second reproduction control information as the reference control information. This allows the recorded digital content to be also reproduced by referring to the second reproduction control information selected as the reference control information. Accordingly, the order of reproducing reproduction digital content by referring to the first reproduction control information, for example, is changed by referring to the second reproduction control information. That is, the order of reproducing the reproduction digital content is edited by switching the reference control information. This allows reproduction of various reproduction digital content items.

In the third inventive digital content reproducing apparatus, the order of reproducing the reproduction digital content by referring to the first reproduction control information and the order of reproducing the reproduction digital content by referring to the second reproduction control information preferably differ from each other.

Then, even only from a storage medium on which recorded digital content and reproduction control information necessary for reproducing the recorded digital content are recorded, the order of reproducing the reproduction digital content is edited.

In the first or second inventive digital content reproducing apparatus including the control information constructing means or the third inventive digital content reproducing apparatus, if the recorded digital content is recorded in a DVD-Video format, the control information constructing means preferably specifies at least one of a start point and an end point at which the order of reproducing the reproduction digital content by referring to the reference control information is edited, by designating a program in the reference control information.

Then, the order of reproducing recorded digital content in the DVD-Video format by referring to the reference control information is edited in units of programs in the DVD-Video format.

In the first or second inventive digital content reproducing apparatus including the control information constructing means or the third inventive digital content reproducing apparatus, if the recorded digital content is recorded in a DVD-Video format, the control information constructing means preferably specifies at least one of a start point and an end point at which the order of reproducing the reproduction digital content by referring to the reference control information is edited, by designating a CELL-ID in the reference control information.

Then, the order of reproducing recorded digital content in the DVD-Video format by referring to the reference control information is edited in units of CELL-IDs in the DVD-Video format.

In the first or second inventive digital content reproducing apparatus including the control information constructing means or the third inventive digital content reproducing apparatus, if the recorded digital content is recorded in a DVD-Video format, the control information constructing means preferably specifies at least one of a start point and an end point at which the order of reproducing the reproduction digital content by referring to the reference control information is edited, by designating a VOBU (video object unit) in the reference control information.

Then, the order of reproducing recorded digital content in the DVD-Video format by referring to the reference control information is edited in units of VOBUs in the DVD-Video format.

In the first or second inventive digital content reproducing apparatus including the control information constructing means or the third inventive digital content reproducing apparatus, if the recorded digital content is recorded in a DVD-Video format, the control information constructing means preferably specifies at least one of a start point and an end point at which the order of reproducing the reproduction digital content by referring to the reference control information is edited, by designating a PTS (presentation time stamp) in the reference control information.

Then, the order of reproducing recorded digital content in the DVD-Video format by referring to the reference control information is edited in units of PTSs in the DVD-Video format.

In the first or second inventive digital content reproducing apparatus including the control information constructing means or the third inventive digital content reproducing apparatus, if the recorded digital content is recorded in a DVD-Video format, the control information constructing means preferably specifies at least one of a start point and an end point at which the order of reproducing the reproduction digital content by referring to the reference control information is edited, by an entry point designating a PTT (part of title) in the reference control information.

Then, the order of reproducing recorded digital content in the DVD-Video format by referring to the reference control information is edited in units of PTTs in the DVD-Video format. In addition, use of the entry point (jump point) designating a PTT in the reproduction control information allows the PTT designated by the entry point to be selected by user operation, for example, and also allows reproduction to start from the selected PTT.

In the first or second inventive digital content reproducing apparatus including the control information constructing means or the third inventive digital content reproducing apparatus, if the recorded digital content is recorded in a DVD-Video format, the control information constructing means preferably specifies at least one of a start point and an end point at which the order of reproducing the reproduction digital content by referring to the reference control information is edited, by an entry point designating a program in the reference control information.

Then, the order of reproducing recorded digital content in the DVD-Video format by referring to the reference control information is edited in units of programs in the DVD-Video format. In addition, use of the entry point (jump point) designating a program in the reproduction control information allows the program designated by the entry point to be selected by user operation, for example, and also allows reproduction to start from the selected program.

In the first or second inventive digital content reproducing apparatus including the control information constructing means or the third inventive digital content reproducing apparatus, if the recorded digital content is recorded in a DVD-Video format, the control information constructing means preferably specifies at least one of a start point and an end point at which the order of reproducing the reproduction digital content by referring to the reference control information is edited, by an entry point designating a CELL-ID in the reference control information.

Then, the order of reproducing recorded digital content in the DVD-Video format by referring to the reference control information is edited in units of CELL-IDs in the DVD-Video format. In addition, use of the entry point (jump point) designating a CELL-ID in the reproduction control information allows the CELL-ID designated by the entry point to be selected by user operation, for example, and also allows reproduction to start from the selected CELL.

In the first or second inventive digital content reproducing apparatus including the control information constructing means or the third inventive digital content reproducing apparatus, if the recorded digital content is recorded in a DVD-Video format, the control information constructing means preferably specifies at least one of a start point and an end point at which the order of reproducing the reproduction digital content by referring to the reference control information is edited, by an entry point designating a VOBU in the reference control information.

Then, the order of reproducing recorded digital content in the DVD-Video format by referring to the reference control information is edited in units of VOBUs in the DVD-Video format. In addition, use of the entry point (jump point) designating a program in the reproduction control information allows the VOBU designated by the entry point to be selected by user operation, for example, and also allows reproduction to start from the selected VOBU.

In the first or second inventive digital content reproducing apparatus including the control information constructing means or the third inventive digital content reproducing apparatus, if the recorded digital content is recorded in a DVD-Video format, the control information constructing means preferably specifies at least one of a start point and an end point at which the order of reproducing the reproduction digital content by referring to the reference control information is edited, by an entry point designating a PTS in the reference control information.

Then, the order of reproducing recorded digital content in the DVD-Video format by referring to the reference control information is edited in units of PTSs in the DVD-Video format. In addition, use of the entry point (jump point) designating a PTS in the reproduction control information allows selection of a frame designated by the entry point and also allows reproduction starting from the frame selected by user operation, for example.

In the first inventive digital content reproducing apparatus, the recorded digital content is preferably encrypted, the second data reading means preferably reads an encryption key from another storage medium on which the encryption key is recorded, the encryption key being used for decrypting an encrypted part of the recorded digital content, and for reproduction of the recorded digital content, the reproducing means preferably decrypts the encrypted part of the recorded digital content using the encryption key.

Then, encrypted recorded digital content which is partly or entirely encrypted is decrypted using an encryption key recorded on a storage medium (e.g., a second storage medium) different from the first storage medium. Accordingly, even if an encryption key for decrypting recorded digital content, for example, is not recorded on the first storage medium, the encrypted recorded digital content is decrypted. In addition, even if secret content which is not reproduced by referring to the first reproduction control information recorded on the second storage medium is recorded on the first storage medium and an encryption key for decrypting the secret content is not recorded on the first storage medium, this secret content is decrypted with the encryption key recorded on the second storage medium. That is, without such a digital content reproducing apparatus including the second data reading means for reading reproduction control information and an encryption key from another storage medium, the secret content is not reproduced from the first storage medium. As a result, illegal reproduction of the secret content is prevented.

In the first inventive digital content reproducing apparatus, the recorded digital content is preferably encrypted, the apparatus preferably further includes third data reading means for reading an encryption key for decrypting an encrypted part of the recorded digital content from another storage medium on which the encryption key is recorded, and for reproduction of the recorded digital content, the reproducing means preferably decrypts the encrypted part of the recorded digital content using the encryption key.

Then, an encryption key recorded on a storage medium (e.g., a second storage medium) different from the first storage medium is read out by the third data reading means, so that encrypted recorded digital content which is partly or entirely encrypted is decrypted with the encryption key. Accordingly, even if an encryption key for decrypting recorded digital content, for example, is not recorded on the first storage medium, the encrypted recorded digital content is decrypted. In addition, even if secret content which is not reproduced by referring to the first reproduction control information recorded on the second storage medium is recorded on the first storage medium and an encryption key for decrypting the secret content is not recorded on the first storage medium, this secret content is decrypted with the encryption key recorded on another storage medium. That is, without such a digital content reproducing apparatus including the third data reading means for reading an encryption key, the secret content is not reproduced from the first storage medium. As a result, protection against illegal reproduction of the secret content is ensured.

A first inventive method for reproducing digital content includes the steps of: reading recorded digital content from a first storage medium on which the recorded digital content is recorded; reading reproduction control information from a second storage medium, the reproduction control information being necessary for reproducing the recorded digital content; and reproducing the recorded digital content as reproduction digital content by referring to the reproduction control information.

With the first inventive digital content reproducing method, reproduction control information necessary for reproducing recorded digital content is read out from the second storage medium different from the first storage medium on which the recorded digital content is recorded. Accordingly, even if the reproduction control information necessary for reproducing the recorded digital content is not recorded on the first storage medium on which the recorded digital content is recorded, the recorded digital content is reproduced by referring to the reproduction control information read out from the second storage medium. In other words, without the first inventive digital content reproducing method, no recorded digital content is reproduced from a storage medium on which no reproduction control information is recorded. Accordingly, protection against illegal reproduction of recorded digital content is ensured. This solves the problem of a conventional method that easiness of breaking a password for reproducing recorded digital content allows illegal reproduction of the recorded digital content by referring to recorded reproduction control information.

A second inventive method for reproducing digital content includes the steps of: reading recorded digital content and first reproduction control information from a first storage medium on which the recorded digital content and the first reproduction control information are recorded, the first reproduction control information being necessary for reproducing the recorded digital content; reading second reproduction control information from a second storage medium on which the second reproduction control information is recorded, the second reproduction control information being necessary for reproducing the recorded digital content; selecting at least one of the first reproduction control information and the second reproduction control information as reference control information which is referred to for reproduction of the recorded digital content; and reproducing the recorded digital content by referring to the reference control information.

With the second inventive digital content reproducing method, at least one of the first reproduction control information recorded on the first storage medium and the second reproduction control information recorded on the second storage medium is selected as the reference control information which is referred to for reproduction of recorded digital content recorded on the first storage medium. Accordingly, the recorded digital content recorded on the first storage medium is reproduced not only by referring to the first reproduction control information recorded on the first storage medium but also by referring to the second reproduction control information recorded on the second storage medium. This allows reproduction of various reproduction digital content items. In addition, if only part of the recorded digital content is reproduced by referring only to the first reproduction control information, reference to the second reproduction control information enables reproduction of part of the recorded digital content which is not reproduced by referring to the first reproduction control information, thus preventing, for example, illegal reproduction of secret content.

In the first or second inventive digital content reproducing method, the recorded digital content is preferably encrypted, the method preferably further includes the step of reading an encryption key for decrypting an encrypted part of the recorded digital content from another storage medium on which the encryption key is recorded, before the step of reproducing the recorded digital content is performed, and the step of reproducing the recorded digital content preferably includes the step of decrypting the recorded digital content using the encryption key.

Then, encrypted part of the recorded digital content which is partly or entirely encrypted is decrypted using an encryption key recorded on a storage medium (e.g., a second storage medium) different from the first storage medium on which recorded digital content is recorded. Accordingly, even if an encryption key for decrypting recorded digital content, for example, is not recorded on the first storage medium, the encrypted recorded digital content is decrypted. In addition, even if secret content which is not reproduced by referring to the second reproduction control information recorded on the second storage medium is recorded on the first storage medium and an encryption key for decrypting the secret content is not recorded on the first storage medium, this secret content is decrypted with the encryption key recorded on the second storage medium. That is, without such a digital content reproducing method with which reproduction control information and an encryption key are read out from another storage medium, the secret content is not reproduced from the first storage medium. As a result, protection against illegal reproduction of the secret content is ensured.

On a first inventive storage medium, recorded digital content and reproduction control information necessary for reproducing the recorded digital content are recorded, and only part of the recorded digital content is reproduced by referring to the reproduction control information.

On the first storage medium, the recorded digital content which is not reproduced by referring only to the recorded reproduction control information is recorded, so that part of the recorded digital content which is not reproduced is treated as secret content that is not illegally reproduced. This solves the problem of a conventional digital content reproducing apparatus that easiness of breaking a password for reproducing recorded digital content allows illegal reproduction of the recorded digital content by referring to recorded reproduction control information.

On the first storage medium, the recorded digital content is preferably encrypted, an encryption key for decrypting an encrypted part of the recorded digital content is preferably also recorded, and only part of the recorded digital content is preferably decrypted by using the encryption key.

Then, only part of the encrypted recorded digital content is reproduced with the recorded encryption key, so that illegal reproduction of part of the recorded digital content which is not decrypted with the encryption key is prevented. In addition, if the part of the recorded digital content which is not decrypted with the encryption key overlaps with a part of the recorded digital content which is not reproduced by referring to the reproduction control information, protection against illegal reproduction is still ensured even in a case where the reproduction control information in this overlapping part is acquired.

A first inventive set of storage media includes: a first storage medium on which recorded digital content and first reproduction control information are recorded, the first reproduction control information being necessary for reproducing the recorded digital content; a second storage medium on which second reproduction control information necessary for reproducing the recorded digital content is recorded, wherein only a specific part of the recorded digital content is reproduced by referring to the first reproduction control information, and the other part of the recorded digital content is reproduced by referring to the second reproduction control information.

With the first set of storage media, recorded digital content recorded on the first storage medium is treated as secret content which is not reproduced by referring only to the first reproduction control information recorded on the first storage medium. Accordingly, protection against illegal reproduction of the secret content is ensured. In addition, the second reproduction control information necessary for reproducing the secret content recorded on the first storage medium is recorded on the second storage medium in the first set of storage media. Accordingly, the combination of at least the first and second storage media allows reproduction of the secret content while preventing illegal reproduction of the secret content.

In the first set of storage media, the recorded digital content is preferably encrypted, and an encryption key for decrypting an encrypted part of the recorded digital content is preferably also recorded on the second storage medium.

Then, the recorded digital content recorded on the first storage medium is encrypted, so that illegal reproduction of the recorded digital content containing secret content is prevented. In addition, an encrypted part of the recorded digital content recorded on the first storage medium is decrypted using the encryption key recorded on the second storage medium. Accordingly, the combination of at least the first and second storage media allows reproduction of encrypted secret content recorded on the first storage medium while preventing illegal reproduction of the secret content.

A fourth inventive digital content reproducing apparatus includes: first data reading means for reading recorded digital content from a first storage medium on which the recorded digital content is recorded in an encrypted form; second data reading means for reading an encryption key for decrypting the recorded digital content from a second storage medium on which the encryption key is recorded; and reproducing means for decrypting the recorded digital content by using the encryption key, for reproduction of the recorded digital content.

In the fourth inventive digital content reproducing apparatus, the second data reading means reads the encryption key which is recorded on the second storage medium and is used for decrypting recorded digital content recorded on the first storage medium. Accordingly, the recorded digital content recorded on the first storage medium is decrypted using the encrypted key read out from the second storage medium. Therefore, even if an encryption key for decrypting the recorded digital content is not recorded on the first storage medium, the encrypted recorded digital content is decrypted. In addition, even if secret content which is not reproduced by referring to the first reproduction control information recorded on the second storage medium is recorded on the first storage medium and an encryption key for decrypting the secret content is not recorded on the first storage medium, the secret content is decrypted with the encryption key recorded on the second storage medium. That is, without such a digital content reproducing apparatus including the second data reading means for reading the encryption key from the second storage medium, the secret content is not reproduced from the first storage medium. As a result, illegal reproduction of digital content including the secret content is prevented.

A fifth inventive digital content reproducing apparatus includes: first data reading means for reading a first encryption key from a first storage medium on which the first encryption key and encrypted recorded digital content are recorded, the first encryption key being used for decrypting a specific part of an encrypted part of the recorded digital content; second data reading means for reading a second encryption key from a second storage medium on which the second encryption key is recorded, the second encryption key being used for decrypting the other part of the encrypted part of the recorded digital content; and reproducing means for decrypting the recorded digital content by using at least one of the first encryption key and the second encryption key, for reproduction of the recorded digital content.

In the fifth inventive digital content reproducing apparatus, recorded digital content recorded on the first storage medium is decrypted using at least one of the first encryption key recorded on the first storage medium and the second encryption key recorded on the second storage medium. Specifically, for example, if part of an encrypted part of the recorded digital content recorded on the first storage medium which is not decrypted with the first encryption key is decrypted using the second encryption key, the recorded digital content is reproduced from the first storage medium. That is, without such a digital content reproducing apparatus including the second data reading means for reading the reproduction control information and the encryption key from the second storage medium, the secret content is not reproduced from the first storage medium. As a result, illegal reproduction of digital content including the secret content is prevented.

In the fourth or fifth inventive digital content reproducing apparatus, the second storage medium is preferably an internal memory, an external memory or a storage medium usable on a network.

Then, even if an encryption key for decrypting recorded digital content is recorded in an internal memory or an external memory or on a storage medium usable on a network, the foregoing advantages are still ensured.

A third inventive method for reproducing digital content includes the steps of: reading recorded digital content from a first storage medium on which the recorded digital content is recorded in an encrypted form; reading an encryption key for decrypting the recorded digital content from a second storage medium on which the encryption key is recorded; and decrypting the recorded digital content by using the encryption key, for reproduction of the recorded digital content.

With the third inventive digital content reproducing method, an encryption key which is recorded on the second storage medium and is used for decrypting recorded digital content recorded on the first storage medium is read out. Accordingly, the recorded digital content recorded on the first storage medium is decrypted using the encryption key read out from the second storage medium. Therefore, even if the encryption key for decrypting the recorded digital content is not recorded on the first storage medium, the recorded digital content is reproduced. In other words, without such a digital content reproducing method including the step of reading the encryption key from the second medium, the secret content is not reproduced from the first storage medium. Accordingly, the secret content is reproduced as intended with protection against illegal reproduction of the secret content ensured.

A fourth inventive method for reproducing digital content includes the steps of: reading recorded digital content and a first encryption key from a first storage medium on which the recorded digital content in an encrypted form and the first encryption key are recorded, the first encryption key being used for decrypting a specific part of an encrypted part of the recorded digital content; reading a second encryption key from a second storage medium on which the second encryption key is recorded, the second encryption key being used for decrypting the other part of the encrypted part of the recorded digital content; and decrypting the recorded digital content by using at least one of the first encryption key and the second encryption key, for reproduction of the recorded digital content.

With the fourth inventive digital content reproducing method, recorded digital content recorded on the first storage medium is decrypted using at least one of the first encryption key recorded on the first storage medium and the second encryption key recorded on the second storage medium. Specifically, for example, if part of an encrypted part of the recorded digital content recorded on the first storage medium which is not decrypted with the first encryption key is decrypted using the second encryption key, the recorded digital content is reproduced from the first storage medium. That is, without such a digital content reproducing method including the step of reading the encryption key from the second storage medium, the secret content is not reproduced from the first storage medium. As a result, illegal reproduction of digital content including the secret content is prevented.

On a second inventive storage medium, encrypted recorded digital content and an encryption key for decrypting the recorded digital content are recorded, and only part of the recorded digital content is decrypted by using the encryption key.

With the second inventive storage medium, only part of recorded digital content is decrypted using a recorded encryption key, so that part of the recorded digital content which is not decrypted with the recorded encryption key is treated as secret content. That is, illegal reproduction of the secret content is prevented.

A second inventive set of storage media includes: a first storage medium on which encrypted recorded digital content is recorded; and a second storage medium on which an encryption key for decrypting the recorded digital content is recorded.

With the second inventive set of storage media, recorded digital content recorded on the first storage medium is decrypted using the encryption key recorded on the second storage medium. Accordingly, the combination of at least the first and second storage media ensures reproduction of recorded digital content recorded on the first storage medium while preventing illegal reproduction of the recorded digital content.

A first inventive method for recording secret content includes the steps of: recording digital content on a storage medium; and recording only reproduction control information necessary for reproducing part of the digital content on the storage medium, wherein the other part of the digital content which is not reproduced by referring to the reproduction control information is treated as secret content.

With the first inventive secret content recording method, digital content and reproduction control information necessary for reproducing part of the digital content are recorded on the storage medium. Accordingly, part of the recorded digital content which is not reproduced by the reproduction control information recorded on the storage medium is treated as secret content, thus preventing illegal reproduction of this secret content.

In the first secret content recording method, the step of recording the digital content preferably includes the step of recording the digital content in an encrypted form on the storage medium.

Then, an encrypted part of digital content is treated as secret content and illegal reproduction of this secret content is prevented. In addition, for a part of the digital content which is not reproduced by referring to the reproduction control information recorded on the storage medium and overlaps with an encrypted part of the digital content, even if reproduction control information in this part is acquired, illegal reproduction thereof is prevented.

A second inventive method for recording secret content includes the steps of: recording encrypted digital content on a storage medium; and recording only an encryption key for decrypting a specific part of an encrypted part of the digital content on the storage medium, wherein the other part of the encrypted part of the digital content is treated as secret content.

With the second inventive secret content recording method, an encryption key for decrypting the part other than the specific part of the encrypted part of encrypted digital content is not recorded on the storage medium, so that the part except for the specific part is treated as secret content and illegal reproduction of this secret content is prevented.

An inventive digital content copying apparatus includes: first data reading means for reading recorded digital content from a first storage medium on which the recorded digital content is recorded; second data reading means for reading first copy control information from a second storage medium on which the first copy control information is recorded, the first copy control information being necessary for copying the recorded digital content; and copying means for copying the recorded digital content as copy digital content by referring to the first copy control information.

In the inventive digital content copying apparatus, the second data reading means reads the first copy control information necessary for copying the recorded digital content from the second storage medium different from the first storage medium on which the recorded digital content is recorded. Accordingly, even if the copy control information necessary for copying the recorded digital content is not recorded on the first storage medium on which the recorded digital content is recorded, reference to the first copy control information enables copying of the recorded digital content. In other words, without the inventive digital content copying apparatus, recorded digital content is not copied from a storage medium on which no reproduction control information is recorded. Hence, the inventive digital content copying apparatus ensures protection against illegal copying of the recorded digital content. This solves the problem of a conventional apparatus that easiness of breaking a password for copying recorded digital content allows illegal copying of the recorded digital content by referring to recorded copy control information.

In the first inventive digital content reproducing apparatus, content copy control information necessary for copying the recorded digital content may be recorded on the first storage medium, the first data reading means may read the content copy control information from the first storage medium, and the apparatus may further include content copy controlling means for preventing copying of content reproduced by the reproducing means on another storage medium if the content copy control information indicates prohibition of copying the recorded digital content from the first storage medium.

As described above, the inventive digital content reproducing apparatus, digital content reproducing methods, storage media, and secret content recording methods enable protection against illegal reproduction of digital content recorded on storage media or editing of the order of reproducing digital content, and therefore are applicable to apparatus such as digital content reproducing apparatus.

### BRIEF DESCRIPTION OF THE DRAWINGS

FIG. 1 is a block diagram showing a configuration of a digital content reproducing apparatus (for navigation data) according to a first embodiment of the present invention.

FIG. 2 is a block diagram showing a configuration of a digital content edit reproducing apparatus (for navigation data) according to a second embodiment of the present invention.

FIG. 3A shows a structure of navigation data 250 recorded on a storage medium 107 shown in FIG. 2. FIG. 3B shows the order of actual data reproduced by referring to the recorded navigation data 250 shown in FIG. 3A. FIG. 3C shows actual data recorded on the storage medium 107 shown in FIG. 2. FIG. 3D shows the order of actual data reproduced by referring to edit navigation data constructed by the digital content edit reproducing apparatus 200 shown in FIG. 2. FIG. 3E shows a structure of the edit navigation data constructed by the digital content edit reproducing apparatus 200 shown in FIG. 2.

FIG. 4 is a view showing a configuration of a storage medium (for navigation data) according to a third embodiment of the present invention.

FIG. 5A shows a structure of recorded navigation data 350 recorded on the storage medium 300 of the third embodiment shown in FIG. 4. FIG. 5B shows actual data reproduced by referring to the recorded navigation data 350 shown in FIG. 5A and actual data not reproduced by the reference. FIG. 5C shows the order of actual data reproduced by referring to the recorded navigation data 350 shown in FIG. 5A.

FIG. 6 is a block diagram showing a configuration of a digital content reproducing apparatus (for encryption keys) according to a fourth embodiment of the present invention.

FIG. 7 is a view showing a configuration of a storage medium (for encryption keys) according to a fifth embodiment of the present invention.

FIG. 8 is a block diagrams showing a configuration of a digital content copying apparatus according to a sixth embodiment of the present invention.

FIG. 9 is a block diagram showing a configuration of a digital content reproducing apparatus according to a seventh embodiment of the present invention.

FIG. 10 is a block diagram showing a configuration of a conventional digital content reproducing apparatus.

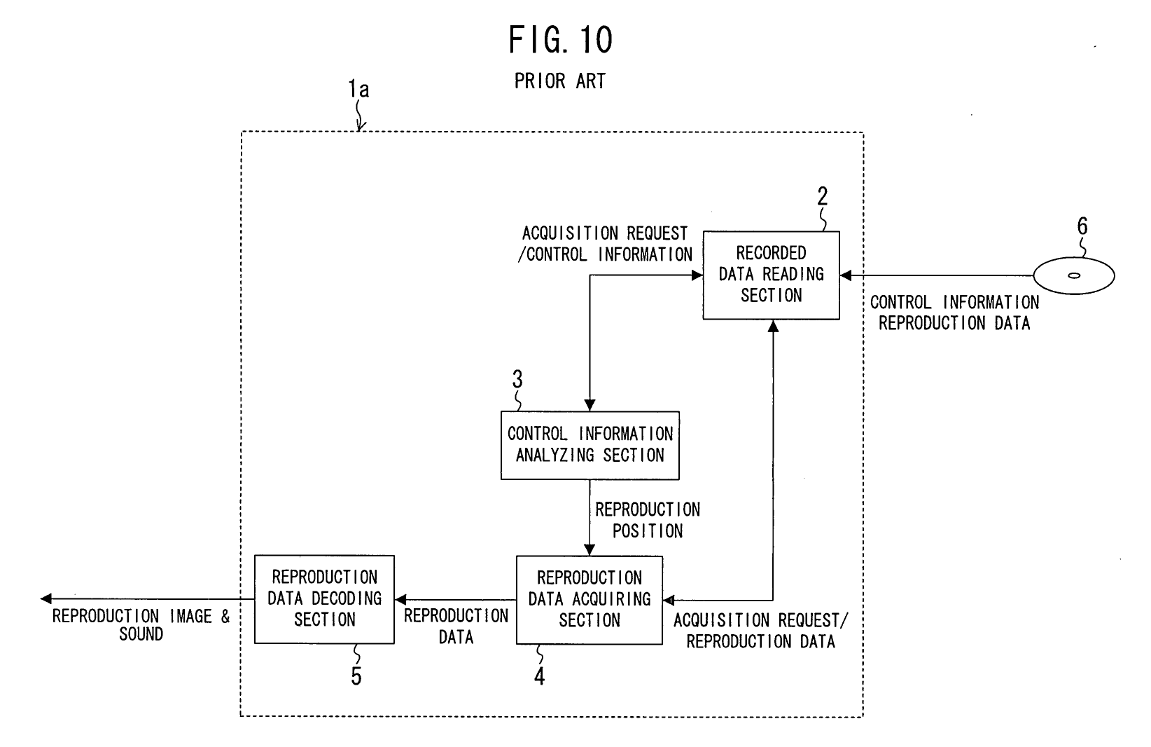

FIG. 11A shows a structure of navigation data 10 recorded on a conventional storage medium. FIG. 11B shows actual data recorded on the storage medium. FIG. 11C shows the order of actual data reproduced by referring to the recorded navigation data 10 shown in FIG. 1A using a conventional digital content reproducing apparatus 1.

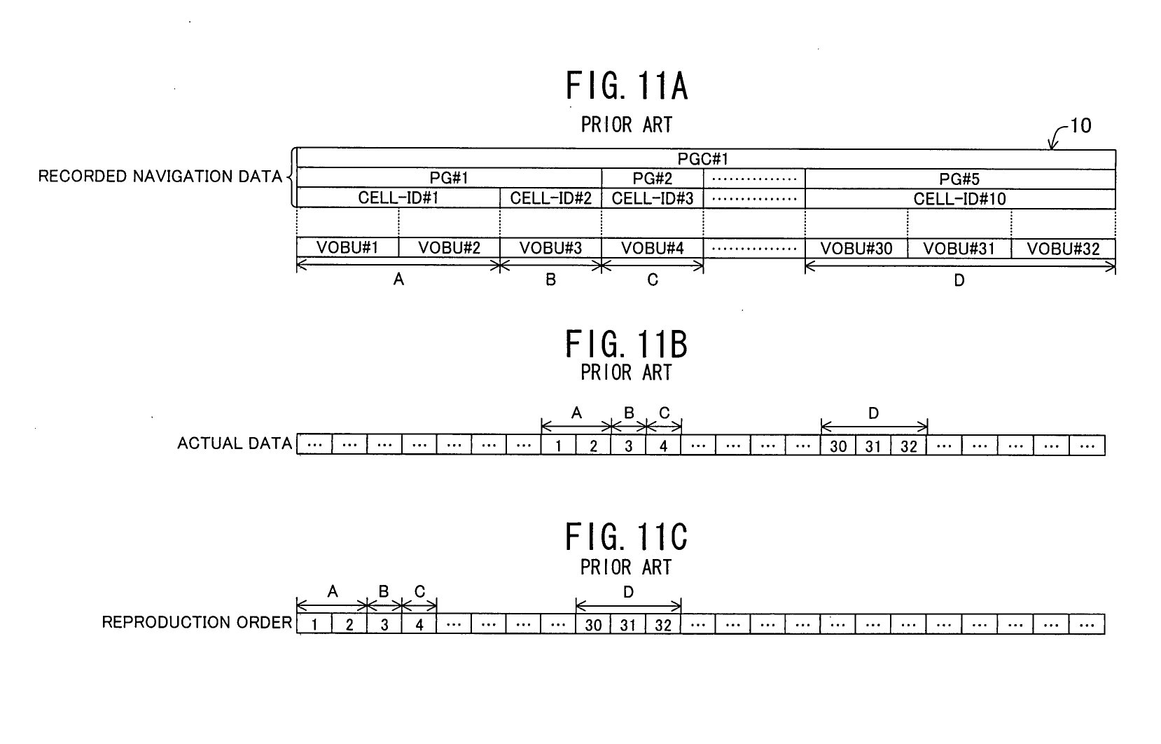

FIG. 12 is a block diagram showing a configuration of a conventional digital content reproducing apparatus.

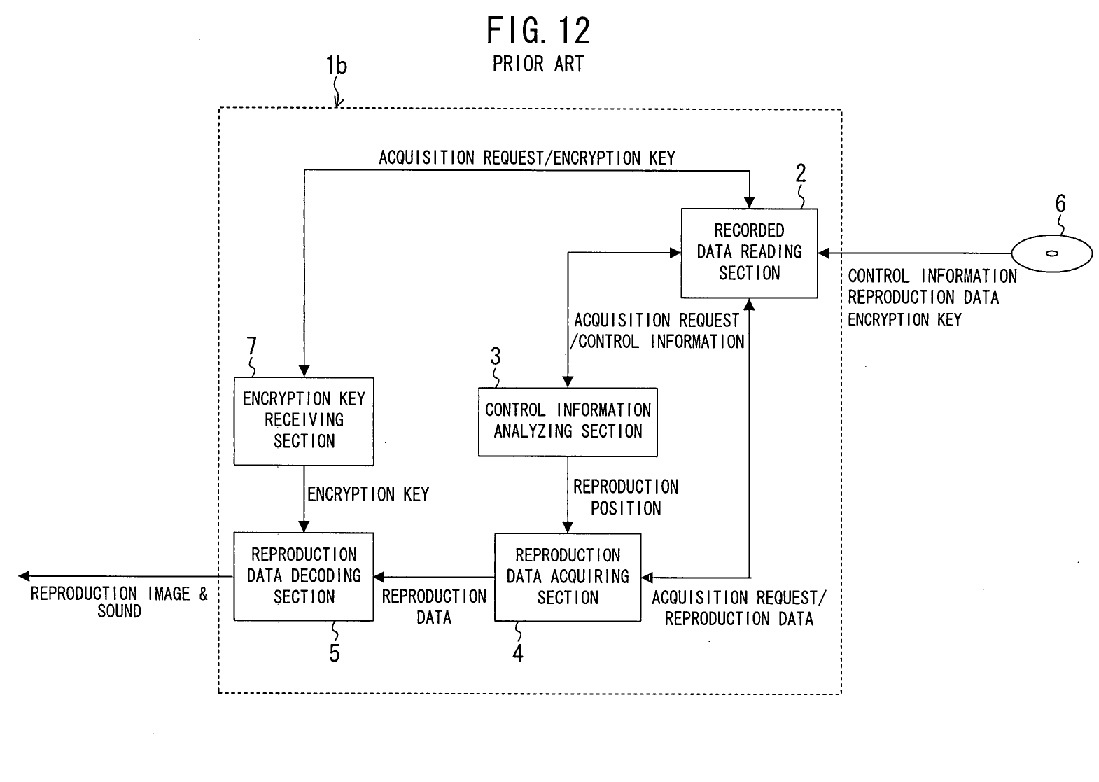

### DESCRIPTION OF THE PREFERRED EMBODIMENTS

Embodiment 1

Hereinafter, a digital content reproducing apparatus according to a first embodiment of the present invention will be described with reference to the drawings.

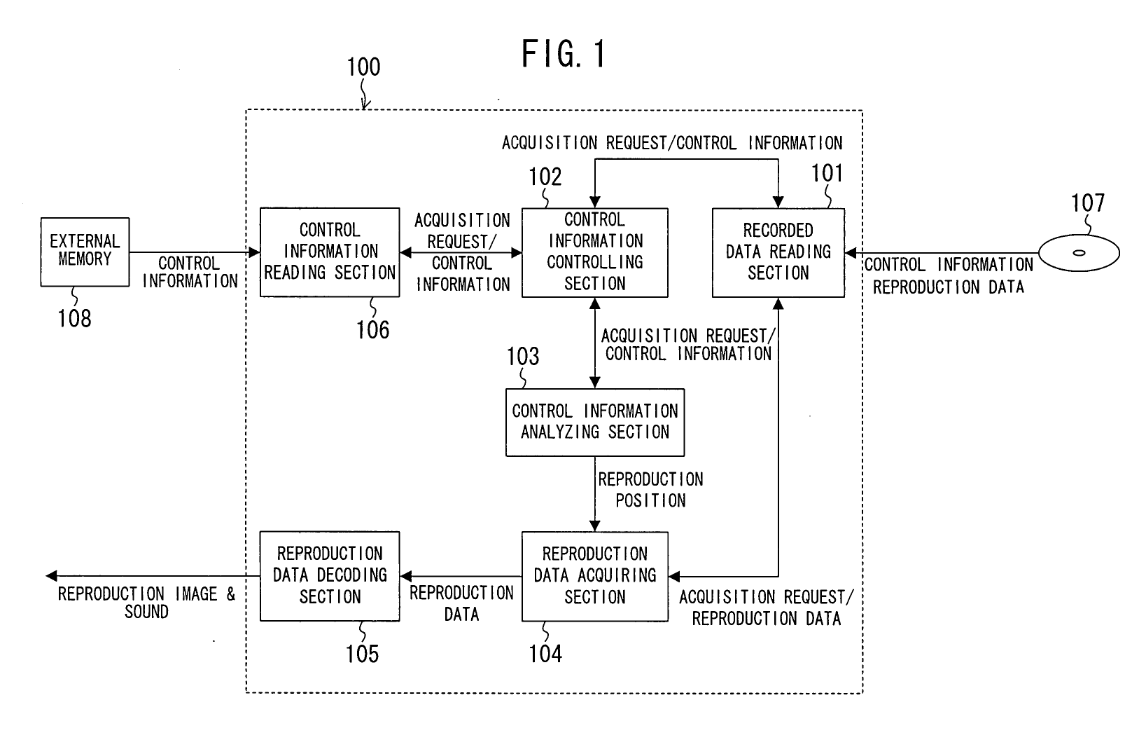

FIG. 1 is a block diagram showing a configuration of the digital content reproducing apparatus of the first embodiment, more specifically, a digital content reproducing apparatus having a function of editing the order (reproduction order) of reproducing digital content recorded on a storage medium (hereinafter, referred to as recorded digital content). The digital content reproducing apparatus of this embodiment is applicable to various digital content and storage media. In this embodiment, an apparatus for producing digital content in the DVD-Video format will be described as an example.

As shown in FIG. 1, the digital content reproducing apparatus 100 of the first embodiment includes: a recorded data reading section 101; a control information controlling section 102; a control information analyzing section 103; a reproduction data acquiring section 104; a reproduction data decoding section 105; and a control information reading section 106.

Now, a process in which recorded digital content is reproduced with the above configuration will be described together with description of functions of the respective components.

First, the control information analyzing section 103 requests the control information controlling section 102 to acquire reproduction control information (navigation data) of video title set information (VTSI) or video manager information (VMGI). At this time, if the apparatus is set such that recorded digital content recorded on a storage medium 107 is reproduced with the reproduction order changed, the control information controlling section 102 requests the control information reading section 106 to acquire navigation data recorded in an external memory 108 (hereinafter, referred to as edit navigation data). Upon the request, the control information reading section 106 reads out the edit navigation data from the external memory 108, and then transmits the edit navigation data to the control information controlling section 102. The control information controlling section 102 sends the received edit navigation data to the control information analyzing section 103. The control information analyzing section 103 refers to the received edit navigation data as edit navigation data to notify the reproduction data acquiring section 104 of a position at which reproduction of data actually recorded on the storage medium 107 starts. Then, the reproduction data acquiring section 104 requests the recorded data reading section 101 to acquire data to be reproduced (hereinafter, referred to as reproduction data). Upon the request, the recorded data reading section 101 reads the requested reproduction data from the storage medium 107 and then transmits this reproduction data to the reproduction data acquiring section 104. The reproduction data acquiring section 104 sends the received reproduction data to the reproduction data decoding section 105. Then, the reproduction data decoding section 105 decodes the reproduction data compressed in the MPEG format. In this manner, pictures and sounds based on the reproduction data are reproduced.

In the case of reproducing recorded digital content using recorded navigation data recorded on the storage medium 107 as edit navigation data as in a conventional reproduction apparatus, in order to acquire edit navigation data, the control information controlling section 102 only needs to request the recorded data reading section 101 to acquire recorded navigation data recorded on the storage medium 107.

In this manner, in the first embodiment, the control information controlling section 102 allows the edit navigation data, which is referred to for reproduction of the recoded digital content, to switch from the recorded navigation data recorded on the storage medium 107 to the edit navigation data recorded in the external memory 108. Accordingly, the order of reproducing reproduction data is changed by referring to the edit navigation data recorded in the external memory 108. In addition, the order of reproducing the reproduction data is easily changed only by switching the object from which the edit navigation data is acquired between the storage medium 107 and the external memory 108. That is, it is possible to easily change the order of reproducing reproduction data while performing conventional reproduction control without a change of components included in the conventional apparatus, such as the recorded data reading section 101, the reproduction data acquiring section 104 and the reproduction data decoding section 105.

In the first embodiment, the external memory 108 may be a nonvolatile external memory, a nonvolatile or volatile internal memory or a storage medium usable on a network.

In addition, in the first embodiment, description is given on the case of acquiring only edit navigation data recorded in the external memory 108. Alternatively, for reproduction of the recorded digital content, both the edit navigation data recorded in the external memory 108 and the recorded navigation data recorded on the storage medium 107 may be acquired so that these navigation data sets are referred to as edit navigation data.

Further, in the first embodiment, the edit navigation data is recorded in the external memory 108. Alternatively, the edit navigation data may be recorded on the storage medium 107. In such a case, the control information controlling section 102 also only needs to request the recorded data reading section 101 to acquire at least one of the recorded navigation data and the edit navigation data from the storage medium 107. In this case, the control information reading section 106 is not necessarily provided. If the edit navigation data is not recorded in the external memory 108, this edit navigation data may be recorded in a part which can be freely used by a user in the area defined by specifications of the storage medium 107, a directory outside an area where the recorded navigation data is written, or an area before the beginning or after the end of a file which cannot be read out by a general drive, or may be recorded as a file name or an extension.

Furthermore, in the first embodiment, the recorded digital content is recorded on the storage medium 107 in the DVD-Video format. However, even in a case where the recorded digital content recorded on the storage medium 107 is based on another format, if control information different from the control information recorded on the storage medium 107 is read out from the external memory 108, the same effects are obtained.

In the first embodiment, one of the recorded navigation data recorded on the storage medium 107 and the edit navigation data recorded in the external memory 108 is selected as the edit navigation data, and then the selected navigation data is acquired. Alternatively, both the recorded navigation data and the edit navigation data may be acquired before selection of one of these data sets as the edit navigation data. In such a case, both the acquired recorded navigation data and edit navigation data may be referred to as edit navigation data.

Embodiment 2

Hereinafter, a digital content edit reproducing apparatus according to a second embodiment of the present invention will be described with reference to the drawings.

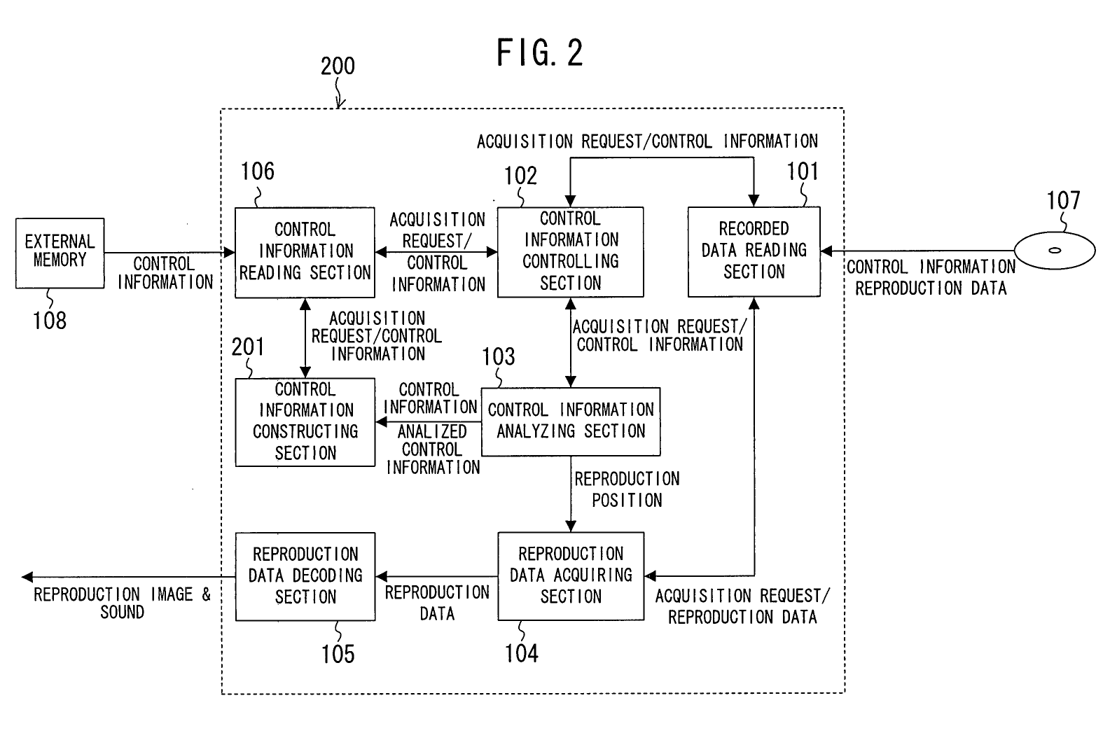

FIG. 2 is a block diagram showing a configuration of the digital content edit reproducing apparatus of the second embodiment, specifically, a digital content edit reproducing apparatus capable of newly constructing control information necessary for reproducing digital content recorded on a storage medium, based on existing control information. In FIG. 2, the same components as those of the digital content reproducing apparatus 100 of the first embodiment shown in FIG. 1 are denoted by the same reference numerals.

As shown in FIG. 2, the digital content edit reproducing apparatus 200 of the second embodiment is characterized by including a control information constructing section 201 capable of newly constructing control information (navigation data) in addition to the configuration of the digital content reproducing apparatus 100 of the first embodiment shown in FIG. 1.

A process in which navigation is newly constructed and then this navigation data is stored in an external memory 108 with the above-described configuration will be described together with description of functions of the respective components.

First, during reproduction of recorded digital content recorded on a storage medium 107 using navigation data (recorded navigation data) recorded on the storage medium 107 and navigation data (edit navigation data) recorded in the external memory 108 as edit navigation data, a user specifies edit points (e.g., start point and end point for an edit) of a scene which is being reproduced. With this specification, a control information analyzing section 103 sends, to a control information constructing section 201, either recorded navigation data regarding these edit points and recorded navigation data which has been analyzed by the control information analyzing section 103 or edit navigation data regarding these edit points and edit navigation data which has been analyzed by the control information analyzing section 103. Then, the control information constructing section 201 requests a control information reading section 106 to acquire edit navigation data recorded in the external memory 108 (if the edit navigation data is recorded in the external memory 108). Upon the request, the control information reading section 106 acquires the edit navigation data from the external memory 108 and transmits the acquired edit navigation data to the control information constructing section 201. The control information constructing section 201 reconstructs the edit navigation data from the control information reading section 106, based on either the recorded navigation data regarding the edit points and the analyzed recorded navigation data or the edit navigation data regarding the edit points and the analyzed edit navigation data received from the control information analyzing section 103. At this time, the navigation data is reconstructed to be in the same form as the recorded navigation data or the edit navigation data such that the digital content recorded on the storage medium 107 is reproduced by referring to the reconstructed edit navigation data. Thereafter, the control information constructing section 201 records the reconstructed edit navigation data in the external memory 108 by way of the control information reading section 106. If the edit navigation data is not recorded in the external memory 108, the edit navigation data only needs to be newly constructed based on the recorded navigation data from the control information analyzing section 103 so that this constructed edit navigation data is recorded in the external memory 108, instead of reconstruction of the edit navigation data recorded in the external memory 108.

Hereinafter, a structure of the edit navigation data newly constructed in the foregoing manner will be described specifically.

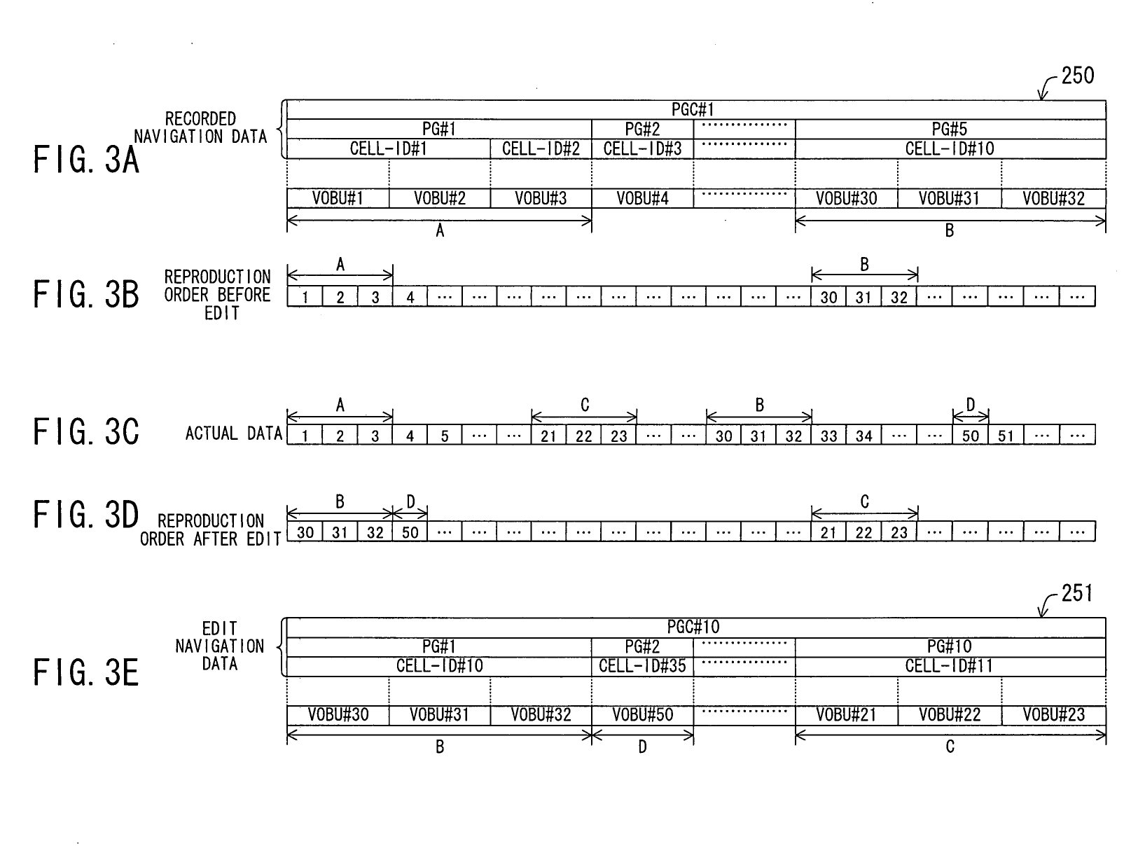

FIG. 3A shows a structure of recorded navigation data 250 recorded on the storage medium 107.

FIG. 3B shows the order (reproduction order) of reproducing recorded digital content recorded on the storage medium 107 shown in FIG. 2 by referring to the recorded navigation data 250 shown in FIG. 3A.

FIG. 3C shows actual data actually recorded on the storage medium 107 in units of VOBUs in VOBSs.

As shown in FIGS. 3A through 3C, in the case of reproducing actual data by referring to the recorded navigation data 250 (PGC#1) shown in FIG. 3A, the actual data shown in FIG. 3C is reproduced in the order shown in FIG. 3B. Specific description thereof has been already given in BACKGROUND OF THE INVENTION, and therefore will be hereinafter omitted.

Now, a structure of edit navigation data newly constructed based on recorded navigation data and the order of reproducing actual data by referring to this edit navigation data will be described.

FIG. 3D shows the order of reproducing actual data to be reproduced using edit navigation data constructed based on the recorded navigation data 250.

FIG. 3E shows a structure of edit navigation data 251 constructed based on the recorded navigation data 250.

As shown in FIG. 3D, in editing the order of reproducing actual data by referring to the recorded navigation data 250, the order of reproducing actual data is specified by designating Cell-IDs in the navigation data in the DVD-Video format, so that the constructed edit navigation data has a structure as shown in FIG. 3E.

As shown in FIG. 3E, PGC#10, for example, constituting the edit navigation data 251 is composed of PG#1 through PG#10 designating respective CELL-IDs in the actual data. For example, CELL-ID#1 corresponding to PG#1 designates VOBU#30 through VOBU#32 in a VOBS of the actual data. In the same manner, CELL-ID#35 corresponding to PG#2 designates VOBU#50 in a VOBS of the actual data. Likewise, CELL-ID#11 corresponding to PG#10 designates VOBU#21 through VOBU#23 in a VOBS of the actual data. Such a structure of the edit navigation data allows reproduction of the actual data in the order shown in FIG. 3D.

As described above, in the second embodiment, edit navigation data which is referred to for reproduction of recorded digital content is newly constructed by the control information constructing section 201. Specifically, the edit navigation data is newly constructed based on the recorded navigation data recorded on the storage medium 107 and, if the edit navigation data has been already recorded in the external memory 108, the recorded edit navigation data is reconstructed. Accordingly, reproduction data is reproduced by referring to the recorded navigation data recorded on the storage medium 107 and, in addition, the order of reproducing reproduction data is changed by referring to constructed (or reconstructed) edit navigation data. That is, the order of reproducing the reproduction data is edited by constructing desired edit navigation data. In addition, the edit navigation data is constructed based on the recorded navigation data, the order of reproducing the reproduction data is edited even from a storage medium on which only one recorded navigation data set is recorded.

In addition, in the second embodiment, the edit navigation data is constructed based on one of the edit navigation data recorded in the external memory 108 and the recorded navigation data recorded on the storage medium 107. Alternatively, the edit navigation data may be constructed based on both the edit navigation data recorded in the external memory 108 and the recorded navigation data recorded on the storage medium 107.

Further, in the second embodiment, edit points for the reproduction data are specified by designating CELL-IDs. Alternatively, the points may be specified by designating PGs.

Furthermore, in the second embodiment, edit points for the reproduction data are specified by designating CELL-IDs. Alternatively, the points may be specified by designating VOBUs designated by CELL-IDs. Then, edit navigation data allowing reproduction data to be edited in units of VOBUs is constructed. In such a case, if the control information analyzing section 103 is configured to analyze the edit navigation data constructed in units of VOBUs, recorded digital content whose reproduction order is edited in units of VOBUs is reproduced by referring to the edit navigation data constructed in units of VOBUs.

Moreover, in the second embodiment, the edit points for the reproduction data are specified by designating CELL-IDs. Alternatively, the edit points may be specified by designating PTSs (presentation time stamps) constituting VOBUs. Then, edit navigation data allowing the reproduction data to be edited in units of frames is constructed. In such a case, if the control information analyzing section 103 is configured to analyze the edit navigation data constructed in units of PTSs, recorded digital content whose reproduction order is edited in units of frames is reproduced by referring to the edit navigation data constructed in units of PTSs.

In the second embodiment, edit points for editing digital content are specified by designating CELL-IDs. If the entry points are specified by designating PTTs (parts of title), PGs, CELL-IDs or PTSs, digital content items edited in units of PTTs, PGs, CELL-IDs or frames are reproduced. Further, entry points (jump points) capable of specifying PTT units, PG units, CELL-ID units or PTS units in the reproduction control information allow PTTs, PGs, CELL-IDs or frames specified by the entry points to be selected by, for example, user operation and also allows reproduction to start from a selected point.

In this manner, if entry points are used, edit points for the reproduction data are specified by the entry points. In addition, the use of entry point offers enhanced convenience. For example, a point immediately after a commercial between TV programs recorded on a DVD-R is marked with an entry point so that the scene can move to the marked point.

Embodiment 3

Hereinafter, a storage medium according to a third embodiment of the present invention will be described with reference to the drawings.

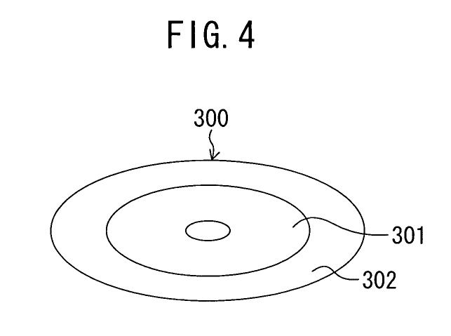

FIG. 4 is a view showing a structure of the storage medium of the third embodiment, specifically, a storage medium in the DVD-Video format on which recorded digital content and navigation data (recorded navigation data) necessary for reproducing the recorded digital content are recorded and from which only part of the recorded digital content is reproduced by referring to the recorded navigation data. In the case of a conventional storage medium, control information for reproducing the entire recorded digital content is recorded thereon.

As shown in FIG. 4, the storage medium 300 of the third embodiment includes: a first content area 301 on which first digital content is recorded; and a second content area 302 on which second digital content is recorded. The first digital content recorded on the first content area 301 of the storage medium 300 is reproduced by referring to recorded navigation data recorded on the storage medium 300. On the other hand, the second digital content recorded on the second content area 302 of the storage medium 300 is not reproduced by referring to the recorded navigation data recorded on the storage medium 300.

Hereinafter, a relationship between the first and second digital content (actual data) recorded on the storage medium 300 of the third embodiment and recorded navigation data will be described.

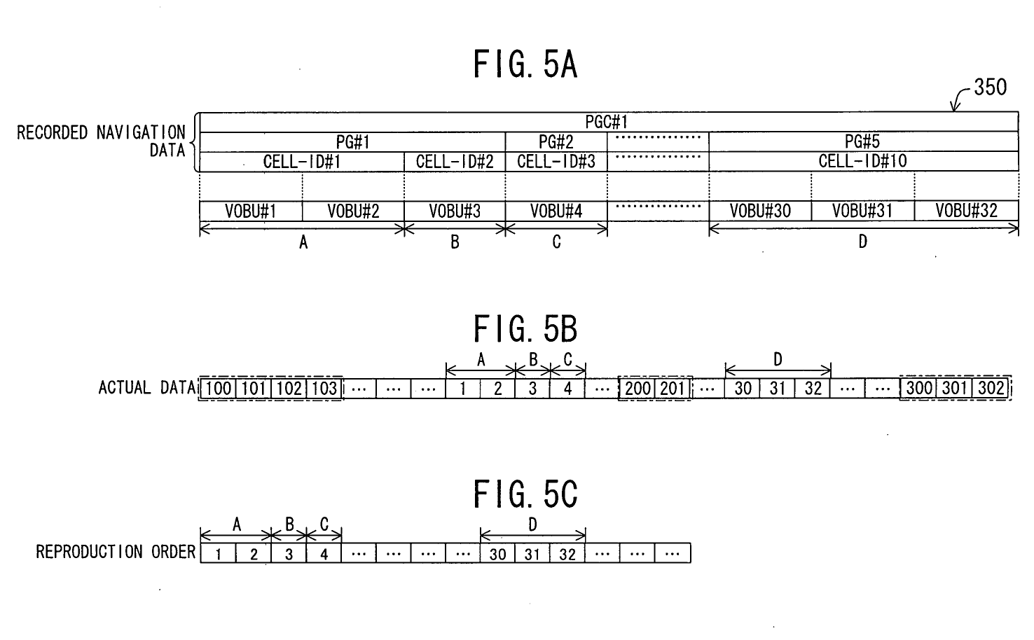

FIG. 5A shows a structure of recorded navigation data 350 composed of only PGC#1, for example.

FIG. 5B shows actual data sets which are reproduced by referring to the recorded navigation data 350 shown in FIG. 5A and actual data sets which are not reproduced by the reference. Each actual data set which is not reproduced is enclosed by a dash-dotted line.

FIG. 5C shows the order (reproduction order) of the actual data sets which are reproduced by referring to the recorded navigation data shown in FIG. 5A, out of the actual data sets shown in FIG. 5B.

As shown in FIG. 5C, the order of reproducing actual data sets which are reproduced by referring to the recorded navigation data 350 is specified by the recorded navigation data 350 shown in FIG. 5A. However, as shown in FIGS. 5A and 5B, the recorded navigation data 350 does not contain information specifying all the actual data sets recorded on the storage medium 300, and therefore actual data sets enclosed by dash-dotted lines shown in FIG. 5B, specifically, VOBUs 100 through 103, VOBUs 200 and 201 and VOBUs 300 through 302, are not included in the actual data sets reproduced in the order shown in FIG. 5C. That is, actual data sets not specified by the recorded navigation data (i.e., the second digital content) are not reproduced, though these actual data sets are recorded on the storage medium 300.

Accordingly, in the third embodiment, navigation data necessary for reproducing the second digital content is not recorded, so that the second digital content is not reproduced by referring to the recorded navigation data. This allows actual data sets not reproduced by referring to the recorded navigation data, such as VOBUs 100 through 103, VOBUs 200 and 201 and VOBUs 300 through 302 shown in FIG. 5B, to be kept as secret content. Even if a password used in a conventional reproducing apparatus is cracked, the absence of navigation data necessary for reproducing the secret content prevents illegal reproduction of the second digital content (secret content).

In a case where data on the storage medium 300 of the third embodiment is encrypted, it is preferable that an encryption key for decrypting digital content containing the second digital content is not recorded on the storage medium 300, or that an encryption key different from an encryption key for decrypting digital content containing the second digital content is recorded on the storage medium 300. Then, even if reproduction control information necessary for reproducing digital content containing the second digital content is referred to, illegal reproduction of the second digital content is prevented.

In the third embodiment, other recorded navigation data necessary for reproducing the second digital content may be recorded on an area not defined by specifications of a storage medium 107. In such a case, other recorded navigation data is also acquired using the digital content reproducing apparatus 100 of the first embodiment shown in FIG. 1, for example. Specifically, first, the control information controlling section 102 of the digital content reproducing apparatus 100 notifies the recorded data reading section 101 of an area which is not defined by specifications and on which other recorded navigation data is recorded, and also requests acquisition of this other recorded navigation data from the notified area of the storage medium 107. Then, the recorded data reading section 101 acquires other recorded navigation data from the area not defined by the specifications of the storage medium 107. The reproduction data is decoded in the manner as described above by referring to the recorded navigation data acquired by the recorded data reading section 101.

In this case, such a digital content reproducing apparatus capable of acquiring recorded navigation data from areas not defined by specifications acquires other recorded navigation data necessary for reproducing the second digital content, though a conventional digital content reproducing apparatus, with which recorded navigation data is not acquired from areas not defined by specifications of the storage medium 107, cannot reproduce the recorded digital content. Accordingly, the second digital content, which is not reproduced without reference to recorded navigation data recorded on an area not defined by specifications of the storage medium 107, is held as secret content. The digital content reproducing apparatus as described above prevents illegal reproduction of secret content. On an area defined by specifications of the storage medium 107 for navigation data, recorded navigation data may not be recorded or incorrect recorded navigation data with which recorded digital content is not correctly decoded may be recorded. In such cases, if other recorded navigation data recorded on an area not defined by specifications of the storage medium 107 is referred to, reproduction of the second digital content is ensured.

Use of a set of storage media including the storage medium 300 of the third embodiment and another storage medium on which other navigation data necessary for reproducing the second digital content recorded on the second content area 302 of the storage medium 300 is recorded prevents illegal reproduction of the second digital content and allows legitimate reproduction of the second digital content.

A method for recording secret content on a storage medium as described in the third embodiment is implemented by including the steps of: recording digital content on a storage medium; and recording only navigation data necessary for reproducing part of the recorded digital content (i.e., the first digital content) on the storage medium as reference control information which is referred to for reproduction of the digital content. As a result, part of the digital content (i.e., the second digital content) which is not reproduced by referring to the recorded navigation data is held as secret content.

To reproduce the second digital content recorded on the storage medium 300 of the third embodiment, it is sufficient to read other recorded navigation data which is recorded on a storage medium different from the storage medium 300 and is necessary for reproducing the second digital content, using the digital content reproducing apparatus of the first embodiment shown in FIG. 1, for example.

Embodiment 4

Hereinafter, a digital content reproducing apparatus according to a fourth embodiment of the present invention will be described with reference to the drawings.

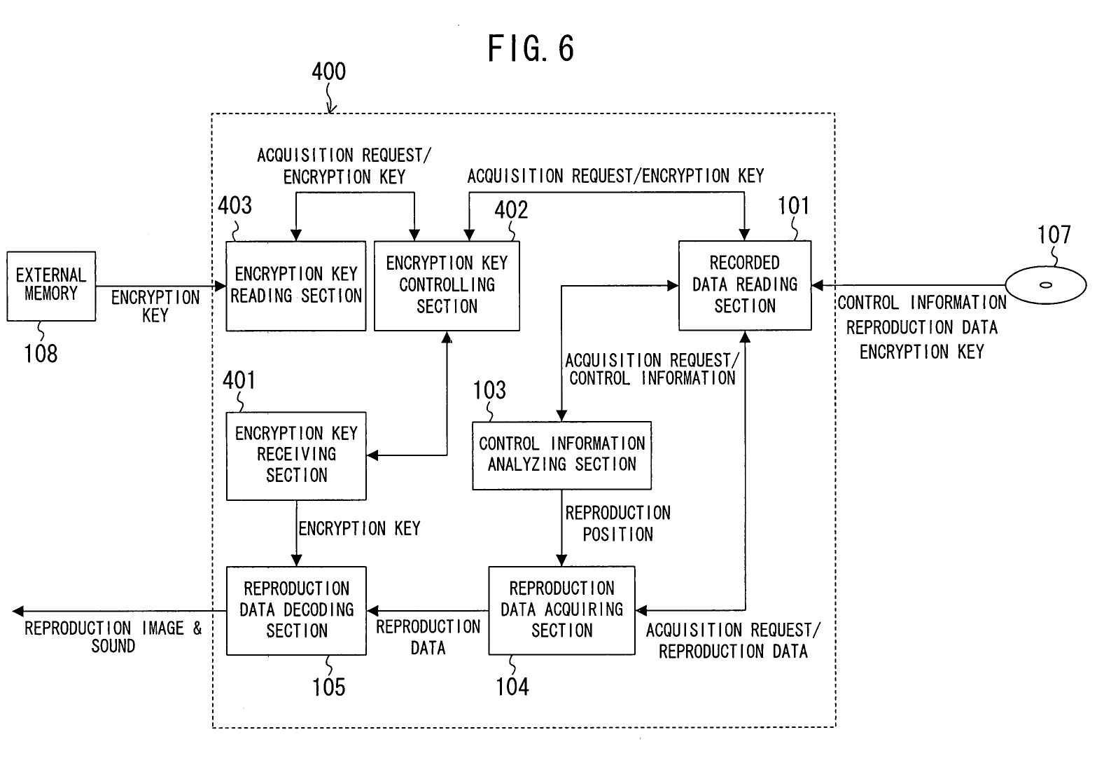

FIG. 6 is a diagram showing a configuration of the digital content reproducing apparatus of the fourth embodiment. In FIG. 6, the same components as those of the digital content reproducing apparatus 100 of the first embodiment shown in FIG. 1 are denoted by the same reference numerals.

As shown in FIG. 6, the digital content reproducing apparatus 400 of this embodiment includes: a recorded data reading section 101; a control information analyzing section 103; a reproduction data acquiring section 104; a reproduction data decoding section 105; an encryption key receiving section 401; an encryption key controlling section 402; and an encryption key reading section 403.

Among these components, the apparatus of this embodiment is characterized by the encryption key controlling section 402 and the encryption key reading section 403. Specifically, even in a case where an encryption key for decrypting recorded digital content recorded on a storage medium 107 is not recorded on the storage medium 107, if an encryption key recorded in an external memory 108, for example, is acquired by the encryption key reading section 403, encrypted recorded digital content is decrypted.

In general, recoded digital content recorded on a storage medium in the DVD-Video format is encrypted by a CSS (content scrambling system), and thereby illegal copying thereof is prevented. Hereinafter, a case where digital content recorded on the storage medium 107 is encrypted by a CSS will be described. It is assumed that an encryption key for decrypting the recorded digital content is not recorded on the storage medium 107 but is recorded in the external memory 108.

In the case of reproducing recorded digital content using an encryption key recorded in the external memory 108, the encryption key receiving section 401 requests the encryption key controlling section 402 to acquire an encryption key recorded in the external memory 108. Then, the encryption key controlling section 402 requests the encryption key reading section 403 to acquire the encryption key from the external memory 108. Upon the request, the encryption key reading section 403 acquires the encryption key from the external memory 108 and then sends the encryption key to the encryption key controlling section 402. The encryption key controlling section 402 sends the received encryption key to the encryption key receiving section 401. The encryption key receiving section 401 sets the received encryption key in the reproduction data decoding section 105. The reproduction data decoding section 105 decrypts reproduction data transmitted from the reproduction data acquiring section 104 using the encryption key which has been set therein. The reproduction data is transmitted to the reproduction data decoding section 105 in the manner already described in the first embodiment.

As described above, in the fourth embodiment, an encryption key recorded in the external memory 108, not the storage medium 107 on which recorded digital content is recorded, is read out by the encryption key reading section 403. In addition, encrypted decoded digital content is decrypted using the encryption key which has been read out. Accordingly, even if the encryption key for decrypting encrypted recorded digital content is not recorded on the storage medium 107, the recorded digital content is decrypted. Specifically, even if an encrypted part of the recorded digital content is illegally read out with a PC or the like, this content cannot be reproduced and is kept as secret content. Accordingly, illegal reproduction of the secret content recorded on the storage medium 107 is prevented.

In the fourth embodiment, the external memory 108 may be a nonvolatile external memory, a nonvolatile or volatile internal memory or a storage medium capable of being used on a network.

In addition, in the fourth embodiment, an encryption key for decrypting a specific part of an encrypted part of the recorded digital content may be recorded on the storage medium 107. In this case, if an encryption key for decrypting the other part of the encrypted part of the recorded digital content is recorded in the external memory 108, this part is protected as secret content and prevented from being illegally copied. In such a case, to decrypt the reproduction data, it is sufficient to use at least one of the encryption key recorded in the external memory 108 and the encryption key recorded on the storage medium 107.

Further, in the fourth embodiment, the encryption key recorded in the external memory 108 may be recorded on an area not defined by specifications of the storage medium 107. In this case, to acquire this encryption key, the encryption key controlling section 402 of the digital content reproducing apparatus 400 notifies the recorded data reading section 101 of the area not defined by specifications where the encryption key is recorded, and requests acquisition of the encryption key from the specified area of the storage medium 107. Thereafter, the recorded data reading section 101 acquires the encryption key from the area not defined by specifications of the storage medium 107. The reproduction data is decrypted using the encryption key acquired by the recorded data reading section 101 in the manner described above.

In this case, a digital content reproducing apparatus capable of acquiring an encryption key also from areas not defined by specifications allows reproduction of recorded digital content, though a conventional digital content reproducing apparatus incapable of acquiring an encryption key from the areas not defined by specifications of the storage medium 107 cannot reproduce recorded digital content. With a digital content reproducing apparatus as described in this embodiment, illegal reproduction of secret content is prevented. On an area defined by specifications of the storage medium 107 for an encryption key, an encryption key may not be recorded or an incorrect encryption key with which recorded digital content is not decrypted may be recorded. In such cases, the recorded digital content is reproduced using an encryption key recorded on an area not defined by specifications of the storage medium 107.

Further, in the fourth embodiment, the control information controlling section 102 and the control information reading section 106 shown in FIG. 1 are preferably further provided. Then, even if secret content which is not reproduced by referring to recorded navigation data recorded on the storage medium 107 is recorded on the storage medium 107 and no encryption key for decrypting the secret content is recorded on the storage medium 107, the secret content is reproduced by referring to the navigation data recorded on the external memory 108 together with the use of an encryption key. Accordingly, protection against illegal reproduction of the secret content recorded on the storage medium 107 is further ensured. Alternatively, the encryption key controlling section 402 and the encryption key reading section 403 may be provided with the function of the control information controlling section 102 and the function of the control information reading section 106, respectively.

Embodiment 5

Hereinafter, a storage medium according to a fifth embodiment of the present invention will be described with reference to the drawings.

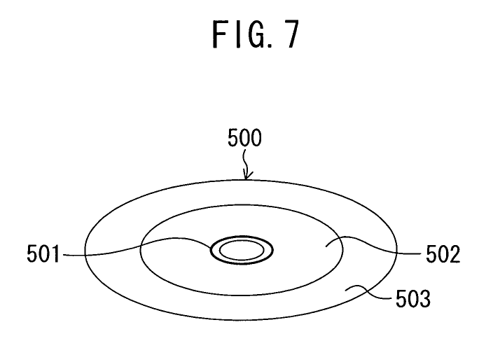

FIG. 7 is a view showing a structure of the storage medium of the fifth embodiment, specifically, a storage medium in the DVD-Video format from which the entire part of recorded digital content is not decrypted with a recorded encryption key.

As shown in FIG. 7, the storage medium 500 of the fifth embodiment includes: an encryption key area 501 on which an encryption key is recorded; a third content area 502 on which third digital content capable of being decrypted with the encryption key recorded on the encryption key area 501 is recorded; and a fourth content area 503 on which fourth digital content incapable of being decrypted with the encryption key recorded on the encryption key area 501 is recorded.

In the fifth embodiment, the encryption key recorded on the encryption key area 501 of the storage medium 500 can be used to decrypt the third digital content recorded on the third content area 502 but cannot be used to decrypt the fourth digital content recorded on the fourth content area 503. Accordingly, illegal reproduction of the fourth digital content recorded on the fourth content area 503 is prevented.

In the fifth embodiment, another encryption key for decrypting the fourth digital content may be recorded on an area not defined by specifications of the storage medium 107. In such a case, this encryption key is acquired using the digital content reproducing apparatus 400 of the fourth embodiment shown in FIG. 6, for example. Specifically, first, the encryption key controlling section 402 of the digital content reproducing apparatus 400 notifies an area not defined by specifications where another encryption key is recorded and requests acquisition of another encryption key from the specified area of the storage medium 107. Upon the request, the recorded data reading section 101 acquires another encryption key from the area not defined by specifications of the storage medium 107. The reproduction data is decrypted using the encryption key acquired by the recorded data reading section 101 in the manner described above.

In this case, a digital content reproducing apparatus capable of acquiring an encryption key also from an area not defined by specifications acquires another encryption key for decrypting the fourth digital content, though a conventional digital content reproducing apparatus incapable of acquiring another encryption key from the area not defined by specifications of the storage medium 107 cannot reproduce the fourth digital content. Accordingly, the fourth digital content, which cannot be decrypted without using another encryption key recorded on the area not defined by specifications of the storage medium 107, is held as secret content. With such a digital content reproducing apparatus as described above, illegal reproduction of secret content is prevented. On an area defined by specifications of the storage medium 107 for an encryption key, no encryption key may be recorded or an incorrect encryption key with which the recorded digital content is not decrypted may be recorded. In such cases, the recorded digital content is reproduced using the encryption key recorded on the area not defined by specifications of the storage medium 107.

Use of a set of storage media including the storage medium 500 of the fifth embodiment and another storage medium on which an encryption key for decrypting recorded digital content recorded on the fourth content area 503 of the storage medium 500 is recorded prevents illegal reproduction of the recorded digital content recorded on the fourth content area 503 of the storage medium 500 and allows reproduction of the digital content with legitimate means.

A method for recording secret content on a storage medium as described in the fifth embodiment is implemented by including the steps of: recording encrypted digital content on a storage medium; and recording only an encryption key for decrypting a specific part (i.e., recorded digital content recorded on the third content area 502) of recorded digital content on the storage medium. As a result, digital content recorded on the area except for the specific part (i.e., recorded digital content recorded on the fourth content area 503) is held as secret content.

Embodiment 6

Hereinafter, a digital content copying apparatus according to a sixth embodiment of the present invention will be described with reference to the drawings.

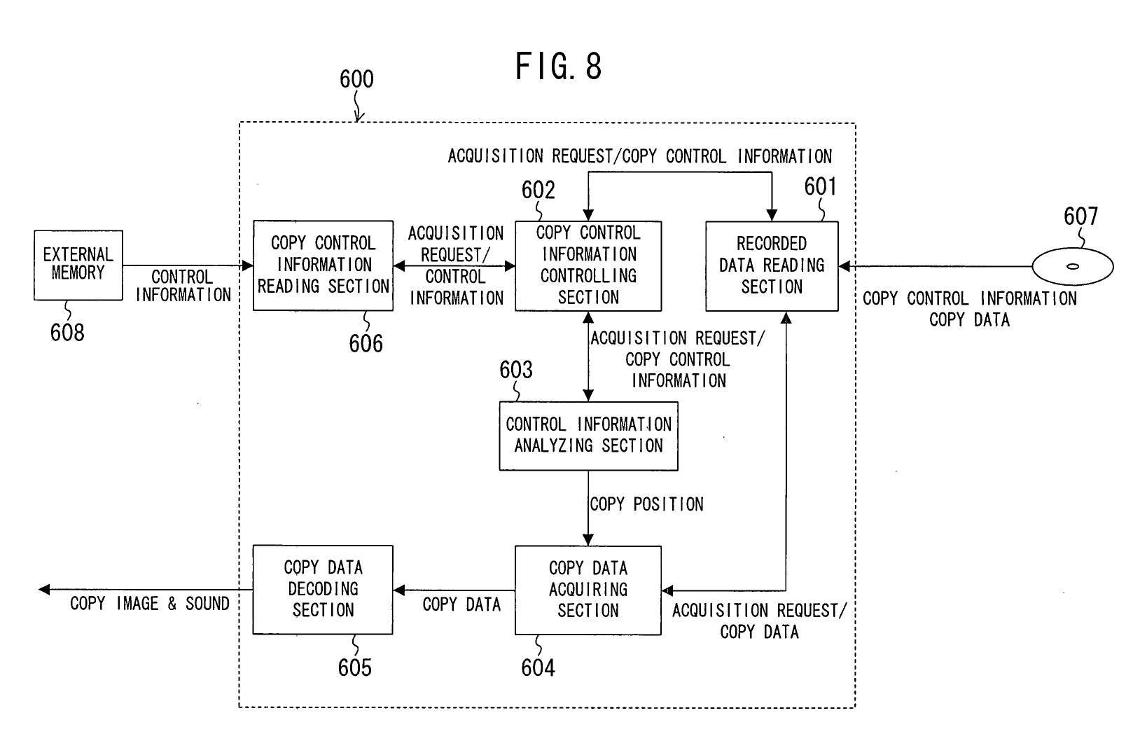

FIG. 8 is a block diagram showing a structure of the digital content copying apparatus of the sixth embodiment, specifically, a digital content copying apparatus having the function of editing the order (copy order) of copying digital content recorded on a storage medium (hereinafter, referred to as recorded digital content). The digital content copying apparatus of this embodiment is applicable to various digital content and storage media. In this embodiment, an apparatus for copying digital content in the DVD-Video format will be described as an example.

As shown in FIG. 8, the digital content copying apparatus 600 of the sixth embodiment includes: a recorded data reading section 601; a copy control information controlling section 602; a control information analyzing section 603; a copy data acquiring section 604; a copy data decrypting section 605; and a copy control information reading section 606.

Now, a process of copying recorded digital content with this configuration will be described together with description of functions of the respective components.

First, the control information analyzing section 603 requests the copy control information controlling section 602 to acquire copy control information (navigation data) of video title set information (VTSI) or video manager information (VMGI). At this time, if the apparatus is set such that recorded digital content recorded on a storage medium 607 with the order of copying changed, the copy control information controlling section 602 requests the copy control information reading section 606 to acquire navigation data recorded in an external memory 608 (hereinafter, referred to as edit navigation data). Then, the copy control information reading section 606 reads out the edit navigation data recorded in the external memory 608, and then transmits the edit navigation data to the copy control information controlling section 602. The copy control information controlling section 602 sends the received edit navigation data to the control information analyzing section 603. The control information analyzing section 603 refers to the received edit navigation data as edit navigation data to notify the copy data acquiring section 604 of a portion at which copying of data actually recorded on the storage medium 607 starts. In response to the notification, the copy data acquiring section 604 requests the recorded data reading section 601 to acquire data to be copied (hereinafter, referred to as copy data). Upon the request, the recorded data reading section 601 reads the requested copy data from the storage medium 607, and then transmits this copy data to the copy data acquiring section 604. The copy data acquiring section 604 sends the received copy data to the copy data decoding section 605. Thereafter, the copy data decoding section 605 decodes the copy data compressed in the MPEG format. In this manner, pictures and sounds based on the copy data are copied.

In the case of reproducing recorded digital content using recorded navigation data recorded on the storage medium 607 as edit navigation data as in the conventional reproduction apparatus, to acquire the edit navigation data, the copy control information controlling section 602 only needs to request the recorded data reading section 601 to acquire the recorded navigation data recorded on the storage medium 607.

In this manner, in the sixth embodiment, the copy control information controlling section 602 allows the edit navigation data, which is referred to in copying recoded digital content, to switch from the recorded navigation data recorded on the storage medium 607 to the edit navigation data recorded in the external memory 608. Accordingly, the order of copying the copy data is changed by referring to the edit navigation data recorded in the external memory 608. In addition, the order of copying the copy data is easily changed only by switching the object from which the edit navigation data is acquired between the storage medium 607 and the external memory 608. That is, it is possible to easily change the order of copying the copy data while performing conventional copy control without a change of components included in the conventional apparatus, such as the recorded data reading section 601, the copy data acquiring section 604 and the copy data decoding section 605.

In the sixth embodiment, the external memory 608 may be a nonvolatile external memory, a nonvolatile or volatile internal memory or a storage medium capable of being used on a network.

In addition, in the sixth embodiment, description is given on the case of acquiring only edit navigation data recorded in the external memory 608. Alternatively, to copy recorded digital content, both the edit navigation data recorded in the external memory 608 and the recorded navigation data recorded on the storage medium 607 may be acquired so that these navigation data sets are referred to as the edit navigation data.

Further, in the sixth embodiment, the edit navigation data is recorded in the external memory 608. Alternatively, the edit navigation data may be recorded on the storage medium 607. In such a case, the copy control information controlling section 602 also only needs to request the recorded data reading section 601 to acquire at least one of the recorded navigation data and the edit navigation data from the storage medium 607. In this case, the copy control information reading section 606 may not be provided. If the edit navigation data is not recorded in the external memory 608, this edit navigation data may be recorded in a part which can be freely used by a user in the area defined by specifications of the storage medium 607, a directory outside an area where the recorded navigation data is written, or an area before the beginning or after the end of a file which cannot be read out by a general drive, or may be recorded as a file name or an extension.

Furthermore, in the sixth embodiment, the recorded digital content is recorded on the storage medium 607 in the DVD-Video format. However, in a case where the recorded digital content recorded on the storage medium 607 is based on another format, if control information different from the control information recorded on the storage medium 607 is read out form the external memory 608, the same effects are obtained.

In the sixth embodiment, one of the recorded navigation data recorded on the storage medium 607 and the edit navigation data recorded in the external memory 608 is selected as the edit navigation data, and then the selected navigation data is acquired. Alternatively, both the recorded navigation data and the edit navigation data may be acquired before selection of one of these data sets as edit navigation data. In such a case, both the acquired recorded navigation data and edit navigation data may be referred to as edit navigation data.

Embodiment 7

Hereinafter, a digital content reproducing apparatus according to a seventh embodiment of the present invention will be described with reference to the drawings.

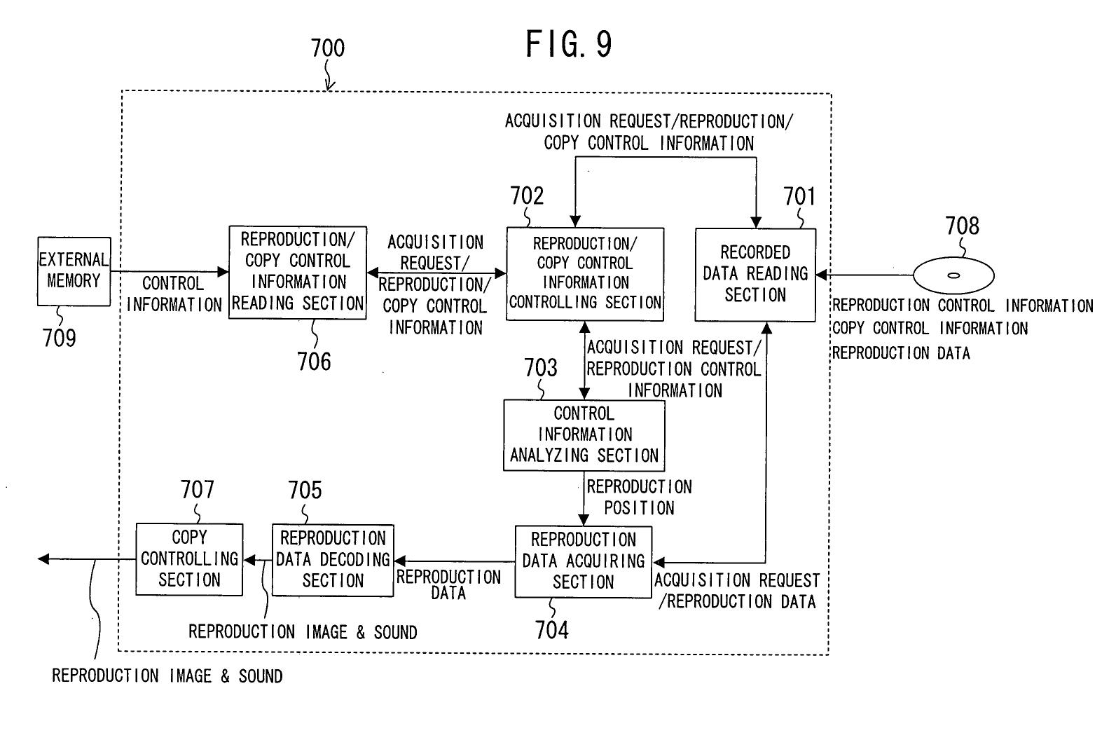

FIG. 9 is a block diagram showing a configuration of the digital content reproducing apparatus of the seventh embodiment, specifically, a digital content reproducing apparatus having the function of editing the order (reproducing order) of reproducing digital content recorded on a storage medium (hereinafter, referred to as recorded digital content). The digital content reproducing apparatus of this embodiment is applicable to various digital content and various storage media. In this embodiment, an apparatus for reproducing digital content in the DVD-Video format will be described as an example.

As shown in FIG. 9, the digital content reproducing apparatus 700 of the seventh embodiment includes: a recorded data reading section 701; a reproduction/copy control information controlling section 702; a control information analyzing section 703; a reproduction data acquiring section 704; a reproduction data decoding section 705; a reproduction/copy control information reading section 706; and a copy controlling section 707.

Now, a process in which recorded digital content is reproduced with the above configuration will be described together with description of functions of the respective components.

First, the control information analyzing section 703 requests the reproduction/copy control information controlling section 702 to acquire reproduction control information (navigation data) of video title set information (VTSI) or video manager information (VMGI). At this time, if the apparatus is set such that recorded digital content recorded on a storage medium 708 is reproduced with the reproduction order changed, the reproduction/copy control information controlling section 702 requests the reproduction/copy control information reading section 706 to acquire navigation data recorded in an external memory 709 (hereinafter, referred to as edit navigation data). Then, the reproduction/copy control information reading section 706 reads out the edit navigation data from the external memory 709, and then transmits this edit navigation data to the reproduction/copy control information controlling section 702. The reproduction/copy control information controlling section 702 sends the received edit navigation data to the control information analyzing section 703. The control information analyzing section 703 refers to the received edit navigation data as edit navigation data to notify the reproduction data acquiring section 704 of a position at which reproduction of data actually recorded on the storage medium 708 starts. In response to the notification, the reproduction data acquiring section 704 requests the recorded data reading section 701 to acquire data to be reproduced (hereinafter, referred to as reproduction data). Upon the request, the recorded data reading section 701 reads the requested reproduction data from the storage medium 708, and then transmits this reproduction data to the reproduction data acquiring section 704. The reproduction data acquiring section 704 sends the received reproduction data to the reproduction data decoding section 705. Then, the reproduction data decoding section 705 decodes the reproduction data compressed in the MPEG format. In this manner, pictures and sounds based on the reproduction data are reproduced. The pictures and sounds reproduced by the reproduction data decoding section 705 are transmitted to the copy controlling section 707.

In the case of reproducing the recorded digital content using the recorded navigation data recorded on the storage medium 708 as the edit navigation data as in the conventional reproduction apparatus, to acquire the edit navigation data, the reproduction/copy control information controlling section 702 only needs to request the recorded data reading section 701 to acquire recorded navigation data recorded on the storage medium 708.

Then, the copy controlling section 707 requests the reproduction/copy control information controlling section 702 to acquire copy control information of video title set information (VTSI) or video manager information (VMGI). Subsequently, the reproduction/copy control information controlling section 702 requests the recorded data reading section 701 to acquire copy control information recorded on the storage medium 708. Upon the request, the recorded data reading section 701 reads copy control information recorded on the storage medium 708, and then sends this copy control information to the reproduction/copy control information controlling section 702. The reproduction/copy control information controlling section 702 transmits the received copy control information to the copy controlling section 707. The copy controlling section 707 refers to the received copy control information and, if the copy control information indicates prohibition of copying of the reproduction data from the storage medium 708, prevents the pictures and sounds reproduced by the reproduction data decoding section 705 from being copied on another storage medium.

In referring to the copy control information recorded in the external memory 709, the reproduction/copy control information controlling section 702 only needs to request the reproduction/copy control information reading section 706 to acquire the copy control information recorded in the external memory 709.

As described above, in the seventh embodiment, the reproduction/copy control information controlling section 702 allows the edit navigation data, which is referred to for reproduction of the recoded digital content, to switch from the recorded navigation data recorded on the storage medium 708 to the edit navigation data recorded in the external memory 709. Accordingly, the order of reproducing reproduction data is changed by referring to the edit navigation data recorded in the external memory 709. In addition, the order of reproducing the reproduction data is easily changed only by switching the object from which the edit navigation data is acquired between the storage medium 708 and the external memory 709. That is, it is possible to easily change the order of reproducing the reproduction data while performing conventional reproduction control without a change of components included in the conventional apparatus, such as the recorded data reading section 701, the reproduction data acquiring section 704 and the reproduction data decoding section 705.

In the seventh embodiment, the external memory 709 may be a nonvolatile external memory, a nonvolatile or volatile internal memory or a storage medium capable of being used on a network.

In addition, in the seventh embodiment, description is given on the case of acquiring only edit navigation data recorded in the external memory 709. Alternatively, to reproduce recorded digital content, both the edit navigation data recorded in the external memory 709 and the recorded navigation data recorded on the storage medium 708 may be acquired so that these navigation data sets are referred to as edit navigation data.

Further, in the seventh embodiment, the edit navigation data is recorded in the external memory 709. Alternatively, the edit navigation data may be recorded on the storage medium 708. In such a case, the reproduction/copy control information controlling section 702 also only needs to request the recorded data reading section 701 to acquire at least one of the recorded navigation data and the edit navigation data from the storage medium 708. In this case, the reproduction/copy control information reading section 706 may not be provided. If the edit navigation data is not recorded in the external memory 709, this edit navigation data may be recorded in a part which can be freely used by a user in the area defined by specifications of the storage medium 707, a directory outside an area where the recorded navigation data is written, or an area before the beginning or after the end of a file which cannot be read out by a general drive, or may be recorded as a file name or an extension.

Furthermore, in the seventh embodiment, the recorded digital content is recorded on the storage medium 708 in the DVD-Video format. However, in a case where the recorded digital content recorded on the storage medium 708 is based on another format, if control information different from the control information recorded on the storage medium 708 is read out from the external memory 709, the same effects are obtained.

In the seventh embodiment, one of the recorded navigation data recorded on the storage medium 708 and the edit navigation data recorded in the external memory 709 is selected as the edit navigation data, and then the selected navigation data is acquired. Alternatively, both the recorded navigation data and the edit navigation data may be acquired before selection of one of these data sets as edit navigation data. In such a case, both the acquired recorded navigation data and edit navigation data may be referred to as edit navigation data.

1. A digital content reproducing apparatus, comprising:
first data reading means for reading recorded digital content from a first storage medium on which the recorded digital content is recorded;
second data reading means for reading first reproduction control information from a second storage medium on which the first reproduction control information is recorded, the first reproduction control information being necessary for reproducing the recorded digital content; and
reproducing means for reproducing the recorded digital content as reproduction digital content by referring to the first reproduction control information.

2. The apparatus of claim 1, wherein second reproduction control information necessary for reproducing the recorded digital content is recorded on the first storage medium,
the first data reading means reads the second reproduction control information,
the apparatus further comprises control information selecting means for selecting, as reference control information which is referred to for reproduction of the recorded digital content, at least one of the first reproduction control information and the second reproduction control information, and
the reproducing means reproduces the recorded digital content by referring to the reference control information.

3. The apparatus of claim 1, wherein the second storage medium is an internal memory, an external memory or a storage medium usable on a network.

4. A digital content reproducing apparatus, comprising:
data reading means for reading recorded digital content, first reproduction control information and second reproduction control information from a storage medium on which the recorded digital content, the first reproduction control information and the second reproduction control information are recorded, the first reproduction control information and the second reproduction control information being necessary for reproducing the recorded digital content;
control information selecting means for selecting, as reference control information which is referred to for reproduction of the recorded digital content, at least one of the first reproduction control information and the second reproduction control information, and
reproducing means for reproducing the recorded digital content as reproduction digital content by referring to the reference control information.

5. The apparatus of claim 2, wherein the order of reproducing the reproduction digital content by referring to the first reproduction control information and the order of reproducing the reproduction digital content by referring to the second reproduction control information differ from each other.

6. The apparatus of claim 4, wherein the order of reproducing the reproduction digital content by referring to the first reproduction control information and the order of reproducing the reproduction digital content by referring to the second reproduction control information differ from each other.

7. The apparatus of claim 2, wherein if the recorded digital content is recorded in a DVD-Video format, each of the first reproduction control information and the second reproduction control information is video title set information (VTSI) or video manager information (VMGI).

8. The apparatus of claim 4, wherein if the recorded digital content is recorded in a DVD-Video format, each of the first reproduction control information and the second reproduction control information is video title set information (VTSI) or video manager information (VMGI).

9. The apparatus of claim 2, further comprising control information constructing means for constructing third reproduction control information based on at least one of the first reproduction control information and the second reproduction control information,
wherein the control information selecting means selects, as the reference control information, at least one of the first reproduction control information, the second reproduction control information and the third reproduction control information.

10. The apparatus of claim 4, further comprising control information constructing means for constructing third reproduction control information based on at least one of the first reproduction control information and the second reproduction control information,
wherein the control information selecting means selects, as the reference control information, at least one of the first reproduction control information, the second reproduction control information and the third reproduction control information.

11. The apparatus of claim 9, wherein the order of reproducing the reproduction digital content by referring to one of the first reproduction control information and the second reproduction control information and the order of reproducing the reproduction digital content by referring to the third reproduction control information differ from each other.

12. A digital content reproducing apparatus, comprising:
reading means for reading recorded digital content and first reproduction control information from a storage medium on which the recorded digital content and the first reproduction control information are recorded, the first reproduction control information being necessary for reproducing the recorded digital content;
control information constructing means for constructing second reproduction control information based on the first reproduction control information;
control information selecting means for selecting, as reference control information which is referred to for reproduction of the recorded digital content, at least one of the first reproduction control information and the second reproduction control information; and
reproducing means for reproducing the recorded digital content as reproduction digital content by referring to the reference control information.

13. The apparatus of claim 12, wherein the order of reproducing the reproduction digital content by referring to the first reproduction control information and the order of reproducing the reproduction digital content by referring to the second reproduction control information differ from each other.

14. The apparatus of claim 9, wherein if the recorded digital content is recorded in a DVD-Video format, the control information constructing means specifies at least one of a start point and an end point at which the order of reproducing the reproduction digital content by referring to the reference control information is edited, by designating a program in the reference control information.

15. The apparatus of claim 12, wherein if the recorded digital content is recorded in a DVD-Video format, the control information constructing means specifies at least one of a start point and an end point at which the order of reproducing the reproduction digital content by referring to the reference control information is edited, by designating a program in the reference control information.

16. The apparatus of claim 9, wherein if the recorded digital content is recorded in a DVD-Video format, the control information constructing means specifies at least one of a start point and an end point at which the order of reproducing the reproduction digital content by referring to the reference control information is edited, by designating a CELL-ID in the reference control information.

17. The apparatus of claim 12, wherein if the recorded digital content is recorded in a DVD-Video format, the control information constructing means specifies at least one of a start point and an end point at which the order of reproducing the reproduction digital content by referring to the reference control information is edited, by designating a CELL-ID in the reference control information.

18. The apparatus of claim 9, wherein if the recorded digital content is recorded in a DVD-Video format, the control information constructing means specifies at least one of a start point and an end point at which the order of reproducing the reproduction digital content by referring to the reference control information is edited, by designating a VOBU (video object unit) in the reference control information.

19. The apparatus of claim 12, wherein if the recorded digital content is recorded in a DVD-Video format, the control information constructing means specifies at least one of a start point and an end point at which the order of reproducing the reproduction digital content by referring to the reference control information is edited, by designating a VOBU (video object unit) in the reference control information.

20. The apparatus of claim 9, wherein if the recorded digital content is recorded in a DVD-Video format, the control information constructing means specifies at least one of a start point and an end point at which the order of reproducing the reproduction digital content by referring to the reference control information is edited, by designating a PTS (presentation time stamp) in the reference control information.

21. The apparatus of claim 12, wherein if the recorded digital content is recorded in a DVD-Video format, the control information constructing means specifies at least one of a start point and an end point at which the order of reproducing the reproduction digital content by referring to the reference control information is edited, by designating a PTS (presentation time stamp) in the reference control information.

22. The apparatus of claim 9, wherein if the recorded digital content is recorded in a DVD-Video format, the control information constructing means specifies at least one of a start point and an end point at which the order of reproducing the reproduction digital content by referring to the reference control information is edited, by an entry point designating a PTT (part of title) in the reference control information.

23. The apparatus of claim 12, wherein if the recorded digital content is recorded in a DVD-Video format, the control information constructing means specifies at least one of a start point and an end point at which the order of reproducing the reproduction digital content by referring to the reference control information is edited, by an entry point designating a PTT (part of title) in the reference control information.

24. The apparatus of claim 9, wherein if the recorded digital content is recorded in a DVD-Video format, the control information constructing means specifies at least one of a start point and an end point at which the order of reproducing the reproduction digital content by referring to the reference control information is edited, by an entry point designating a program in the reference control information.

25. The apparatus of claim 12, wherein if the recorded digital content is recorded in a DVD-Video format, the control information constructing means specifies at least one of a start point and an end point at which the order of reproducing the reproduction digital content by referring to the reference control information is edited, by an entry point designating a program in the reference control information.

26. The apparatus of claim 9, wherein if the recorded digital content is recorded in a DVD-Video format, the control information constructing means specifies at least one of a start point and an end point at which the order of reproducing the reproduction digital content by referring to the reference control information is edited, by an entry point designating a CELL-ID in the reference control information.

27. The apparatus of claim 12, wherein if the recorded digital content is recorded in a DVD-Video format, the control information constructing means specifies at least one of a start point and an end point at which the order of reproducing the reproduction digital content by referring to the reference control information is edited, by an entry point designating a CELL-ID in the reference control information.

28. The apparatus of claim 9, wherein if the recorded digital content is recorded in a DVD-Video format, the control information constructing means specifies at least one of a start point and an end point at which the order of reproducing the reproduction digital content by referring to the reference control information is edited, by an entry point designating a VOBU in the reference control information.

29. The apparatus of claim 12, wherein if the recorded digital content is recorded in a DVD-Video format, the control information constructing means specifies at least one of a start point and an end point at which the order of reproducing the reproduction digital content by referring to the reference control information is edited, by an entry point designating a VOBU in the reference control information.

30. The apparatus of claim 9, wherein if the recorded digital content is recorded in a DVD-Video format, the control information constructing means specifies at least one of a start point and an end point at which the order of reproducing the reproduction digital content by referring to the reference control information is edited, by an entry point designating a PTS in the reference control information.

31. The apparatus of claim 12, wherein if the recorded digital content is recorded in a DVD-Video format, the control information constructing means specifies at least one of a start point and an end point at which the order of reproducing the reproduction digital content by referring to the reference control information is edited, by an entry point designating a PTS in the reference control information.

32. The apparatus of claim 1, wherein the recorded digital content is encrypted,
the second data reading means reads an encryption key from another storage medium on which the encryption key is recorded, the encryption key being used for decrypting an encrypted part of the recorded digital content, and
for reproduction of the recorded digital content, the reproducing means decrypts the encrypted part of the recorded digital content using the encryption key.

33. The apparatus of claim 1, wherein the recorded digital content is encrypted,
the apparatus further comprises third data reading means for reading an encryption key for decrypting an encrypted part of the recorded digital content from another storage medium on which the encryption key is recorded, and
for reproduction of the recorded digital content, the reproducing means decrypts the encrypted part of the recorded digital content using the encryption key.

34. A method for reproducing digital content, the method comprising the steps of:
reading recorded digital content from a first storage medium on which the recorded digital content is recorded;
reading reproduction control information from a second storage medium, the reproduction control information being necessary for reproducing the recorded digital content; and
reproducing the recorded digital content as reproduction digital content by referring to the reproduction control information.

35. A method for reproducing digital content, the method comprising the steps of:
reading recorded digital content and first reproduction control information from a first storage medium on which the recorded digital content and the first reproduction control information are recorded, the first reproduction control information being necessary for reproducing the recorded digital content;
reading second reproduction control information from a second storage medium on which the second reproduction control information is recorded, the second reproduction control information being necessary for reproducing the recorded digital content;
selecting at least one of the first reproduction control information and the second reproduction control information as reference control information which is referred to for reproduction of the recorded digital content; and
reproducing the recorded digital content by referring to the reference control information.

36. The method of claim 34, wherein the recorded digital content is encrypted,
the method further comprises the step of reading an encryption key for decrypting an encrypted part of the recorded digital content from another storage medium on which the encryption key is recorded, before the step of reproducing the recorded digital content is performed, and
the step of reproducing the recorded digital content includes the step of decrypting the recorded digital content using the encryption key.

37. The method of claim 35, wherein the recorded digital content is encrypted,
the method further comprises the step of reading an encryption key for decrypting an encrypted part of the recorded digital content from another storage medium on which the encryption key is recorded, before the step of reproducing the recorded digital content is performed, and
the step of reproducing the recorded digital content includes the step of decrypting the recorded digital content using the encryption key.

38. A storage medium, on which recorded digital content and reproduction control information are recorded, the reproduction control information being necessary for reproducing the recorded digital content,
wherein only part of the recorded digital content is reproduced by referring to the reproduction control information.

39. The storage medium of claim 38, wherein the recorded digital content is encrypted,
an encryption key for decrypting an encrypted part of the recorded digital content is also recorded on the storage medium, and
only part of the recorded digital content is decrypted by using the encryption key.

40. A set of storage media, comprising:
a first storage medium on which recorded digital content and first reproduction control information are recorded, the first reproduction control information being necessary for reproducing the recorded digital content;
a second storage medium on which second reproduction control information necessary for reproducing the recorded digital content is recorded,
wherein only a specific part of the recorded digital content is reproduced by referring to the first reproduction control information, and
the other part of the recorded digital content is reproduced by referring to the second reproduction control information.

41. The set of storage media of claim 40, wherein the recorded digital content is encrypted, and
an encryption key for decrypting an encrypted part of the recorded digital content is also recorded on the second storage medium.

42. A digital content reproducing apparatus, comprising:
first data reading means for reading recorded digital content from a first storage medium on which the recorded digital content is recorded in an encrypted form;
second data reading means for reading an encryption key for decrypting the recorded digital content from a second storage medium on which the encryption key is recorded; and
reproducing means for decrypting the recorded digital content by using the encryption key, for reproduction of the recorded digital content.

43. A digital content reproducing apparatus, comprising:
first data reading means for reading a first encryption key from a first storage medium on which the first encryption key and encrypted recorded digital content are recorded, the first encryption key being used for decrypting a specific part of an encrypted part of the recorded digital content;
second data reading means for reading a second encryption key from a second storage medium on which the second encryption key is recorded, the second encryption key being used for decrypting the other part of the encrypted part of the recorded digital content; and
reproducing means for decrypting the recorded digital content by using at least one of the first encryption key and the second encryption key, for reproduction of the recorded digital content.

44. The apparatus of claim 42, wherein the second storage medium is an internal memory, an external memory or a storage medium usable on a network.

45. The apparatus of claim 43, wherein the second storage medium is an internal memory, an external memory or a storage medium usable on a network.

46. A method for reproducing digital content, the method comprising the steps of:
reading recorded digital content from a first storage medium on which the recorded digital content is recorded in an encrypted form;
reading an encryption key for decrypting the recorded digital content from a second storage medium on which the encryption key is recorded; and
decrypting the recorded digital content by using the encryption key, for reproduction of the recorded digital content.

47. A method for reproducing digital content, the method comprising the steps of:
reading recorded digital content and a first encryption key from a first storage medium on which the recorded digital content in an encrypted form and the first encryption key are recorded, the first encryption key being used for decrypting a specific part of an encrypted part of the recorded digital content;
reading a second encryption key from a second storage medium on which the second encryption key is recorded, the second encryption key being used for decrypting the other part of the encrypted part of the recorded digital content; and
decrypting the recorded digital content by using at least one of the first encryption key and the second encryption key, for reproduction of the recorded digital content.

48. A storage medium, on which encrypted recorded digital content and an encryption key for decrypting the recorded digital content are recorded,
wherein only part of the recorded digital content is decrypted by using the encryption key.

49. A set of storage media, comprising:
a first storage medium on which encrypted recorded digital content is recorded; and
a second storage medium on which an encryption key for decrypting the recorded digital content is recorded.

50. A method for recording secret content, the method comprising the steps of:
recording digital content on a storage medium; and
recording only reproduction control information necessary for reproducing part of the digital content on the storage medium,
wherein the other part of the digital content which is not reproduced by referring to the reproduction control information is treated as secret content.

51. The method of claim 50, wherein the step of recording the digital content includes the step of recording the digital content in an encrypted form on the storage medium.

52. A method for recording secret content, the method comprising the steps of:
recording encrypted digital content on a storage medium; and
recording only an encryption key for decrypting a specific part of an encrypted part of the digital content on the storage medium,
wherein the other part of the encrypted part of the digital content is treated as secret content.

53. A digital content copying apparatus, comprising:
first data reading means for reading recorded digital content from a first storage medium on which the recorded digital content is recorded;
second data reading means for reading first copy control information from a second storage medium on which the first copy control information is recorded, the first copy control information being necessary for copying the recorded digital content; and
copying means for copying the recorded digital content as copy digital content by referring to the first copy control information.

54. The apparatus of claim 1, wherein content copy control information necessary for copying the recorded digital content is recorded on the first storage medium,
the first data reading means reads the content copy control information from the first storage medium, and
the apparatus further comprises content copy controlling means for preventing copying of content reproduced by the reproducing means on another storage medium if the content copy control information indicates prohibition of copying the recorded digital content from the first storage medium.
